(19) United States
(12) Patent Application Publication
(10) Pub. No.: US 2024/0169098 A1
(43) Pub. Date: May 23, 2024

(54) Secure Chip-Wide Transmission

(71) Applicant: Google LLC, Mountain View, CA (US)

(72) Inventors: Timothy Jay Chen, Pleasanton, CA (US); Michael Stefano Fritz Schaffner, Campbell, CA (US); Christopher Gori, San Francisco, CA (US); Eunchan Kim, San Jose, CA (US); Donald Shanahan Sanders, Los Altos, CA (US); Miguel Angel Osorio Lozano, El Dorado Hills, CA (US)

(73) Assignee: Google LLC, Mountain View, CA (US)

(21) Appl. No.: 18/552,602

(22) PCT Filed: Apr. 7, 2022
(86) PCT No.: PCT/US2022/071604

§ 371 Date: Sep. 26, 2023

Related U.S. Application Data
(60) Provisional application No. 63/173,221, filed on Apr. 9, 2021.

(51) Int. Cl. G06F 21/64; G06F 11/10; G06F 21/55

(52) U.S. Cl. CPC G06F 21/64; G06F 11/1004; G06F 21/554

(57) ABSTRACT

This document discloses aspects of secure chip-wide communication. In some aspects, a host of a system generates integrity metadata for a command payload issued to a destination over an interconnect of the system. The integrity metadata can be generated based on respective values of bits that form the command payload, such as plaintext data bits. The destination validates the integrity of the command payload based on the integrity metadata before consuming the command payload. In some cases, the destination stores the integrity metadata with data of the command payload, which may be returned to the host along the data when requested. By so doing, the host and destinations of the system can use the integrity metadata to implement secure-chip wide communication, which may prevent fault injection attacks on the command payloads or response data during transit or at temporal storage locations within the system.

### BACKGROUND

As a result of the ever-increasing computerization of society, and the growing reliance upon personal computing devices to store sensitive user information and perform a variety of operations for its users, including operating vehicles, performing user authentication, and completing digital currency transactions, the world is increasingly susceptible to a variety of costly attacks on sensitive information of computing devices.

Recent fault-based cryptanalysis methods have identified potentially security-threatening methods involving fault injection attacks. A fault injection attack involves an attacker physically injecting, as opposed to a software injection, a fault into a computing system, thereby intentionally altering the behavior of an electronic component. As a result, fault injection attacks can circumvent many low-level system security features, alter a computing system behavior to accomplish malicious intents, and/or extract sensitive information. A fault injection attack may involve voltage glitching, clock glitching, laser injection, electromagnetic injection, and so forth. In some instances, these attacks can introduce fault injections in various locations to break or weaken electronic system security. Thus, fault injection attacks may alter a command or data being transferred within the computing system and can potentially alter execution flow of the system to cause downstream problems such as key leakage, privilege escalation, or unintentional execution of code.

### SUMMARY

This document describes apparatuses and techniques for secure chip-wide communication. In some aspects, a host of a system generates integrity metadata for a command payload issued to a destination over an interconnect (e.g., fabric, bus, channel, etc.) of the system. The integrity metadata can be generated based on respective values of bits that form the command payload, such as plaintext data bits. The destination validates the integrity of the command payload based on the integrity metadata before consuming the command payload. In some cases, the destination stores the integrity metadata with data of the command payload, which may be returned to the host along the data when requested. Additionally, when the destination is a memory, the data may be scrambled before storing the data to protect the data when stored in the memory. When forming response payloads, the destination may also generate integrity data for the data of the response payload. On receipt of the response payload, the host can validate the integrity of the response payload based on the returned integrity bits or the integrity bits generated by the destination. By so doing, the host and various destinations (e.g., memories or peripherals) of the system can use the integrity metadata to implement secure-chip wide communication, which may prevent fault injection attacks on the command payloads or response data during transit or at temporal storage locations within the system.

This Summary is provided to introduce simplified concepts for implementing secure chip-wide communication, which is further described below in the Detailed Description and is illustrated in the Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of secure chip-wide communication are described throughout the disclosure with reference to the Drawings. The use of the same reference numbers in different instances in the description and the figures indicate same or similar elements:

FIG. 1 illustrates an example operating environment that includes apparatuses that may implement aspects of secure chip-wide communication:

FIG. 2 illustrates an example system that includes a processor and multiple circuit components that can implement aspects of secure chip-wide communication:

FIGS. 3A and 3B illustrate an example configuration of system components that implement command or data transactions in accordance with one or more aspects:

FIG. 4 illustrates an example system that includes integrity functions for implementing aspects of secure chip-wide communication:

FIG. 5 illustrates an example destination that includes integrity functions for implementing aspects of secure chip-wide communication:

FIG. 6 illustrates an example memory component that includes integrity functions for implementing aspects of secure chip-wide communication;

FIG. 7 illustrates example methods for secure chip-wide communication that may be implemented by a host in accordance with one or more aspects:

FIG. 8 illustrates example methods for secure chip-wide communication that may be implemented by a destination in accordance with one or more aspects:

FIG. 9 illustrates an example method for verifying integrity of a payload of a message before consuming the payload in accordance with one or more aspects:

FIG. 10 illustrates an example method for writing data of a command message that includes integrity bits to memory in accordance with one or more aspects:

FIG. 11 illustrates examples of instruction cache data transactions in accordance with one or more aspects of secure chip-wide communication:

FIG. 12 illustrates examples of static random-access memory data transactions in accordance with one or more aspects of secure chip-wide communication:

FIG. 13 illustrates an example method for accessing data of a memory and transmitting the data with integrity bits in accordance with one or more aspects:

FIG. 14 illustrates an example method for writing data of a command message in memory with error correcting code bits in accordance with one or more aspects:

FIG. 15 illustrates examples of Flash memory data transactions in accordance with one or more aspects of secure chip-wide communication:

FIG. 16 illustrates an example method for accessing a data of a memory and transmitting the data with generated integrity bits in accordance with one or more aspects: and

FIG. 17 illustrates an example System-on-Chip that may implement aspects of secure chip-wide communication.

### DETAILED DESCRIPTION

Computing systems often include an integrated circuit with security circuitry and software to provide a measure of protection against defects, attacks, and other potentially compromising events. In today's computing environment, bad actors can attack computing devices at a myriad of levels using a multitude of attack vectors. For example, fault injection attacks reduce the protection many of these security paradigms afford. Fault injection attacks can bypass system security features, alter a system behavior to accomplish malicious intents, and/or uncover confidential information. Using a fault injection attack, an attacker can indirectly or directly alter programmed operations of an electronic component (e.g., a central processing unit) using glitches (e.g., sudden, temporary, injected faults in a system). Such an attack can sometimes “brick” a computing device, but in other instances, precise and targeted attacks can introduce compromising security threats. For example, fault injection attacks can allow adversaries to undermine the control flow of a program, which may result in an incorrect function getting called, such as in “return to libc” type attacks. In some cases, these attacks may cause the computing device to expose sensitive data or execute unverified code. Thus, fault injection attacks may alter a command or data being transferred within the computing system and can potentially alter execution flow of the system to cause downstream problems such as key leakage, privilege escalation, or unintentional execution of code.

Preceding techniques aimed at addressing such attacks, however, are typically weak and ineffective at preventing attackers from compromising system security. In some cases, data parity is used as a bus-only security scheme for data communicated between components of a system. This type of parity-based scheme suffers from numerous issues, such as allowing an attacker a fifty percent chance of getting an attack through, being bus-only instead of end-to-end in that an attacker can simply shift the focus to system end points, and attacks on scrambled data may not provide correct results, but there may be no way for a consumer to know the data is wrong, it may simply look different. Accordingly, preceding techniques intended to prevent the above-described attacks often fail to prevent system intrusion or simply shift the attacks to vulnerable system endpoints where data is less protected.

In contrast with preceding security techniques, this disclosure describes aspects of secure chip-wide communication. In aspects, a host of a system generates integrity metadata for a command payload issued to a destination over a fabric of the system. The integrity metadata can be generated based on respective values of bits that form the command payload, such as plaintext data bits. The destination validates the integrity of the command payload based on the integrity metadata before consuming the command payload. In some cases, the destination stores the integrity metadata with data of the command payload, which may be returned to the host along the data when requested. Additionally, when the destination is a memory, the data may be scrambled before storing the data to protect the data when stored in the memory. When forming response payloads, the destination may also generate integrity data for the data of the response payload. On receipt of the response payload, the host can validate the integrity of the response payload based on the returned integrity bits or the integrity bits generated by the destination. By so doing, the host and various destinations (e.g., memories or peripherals) of the system can use the integrity metadata to implement secure-chip wide communication, which may prevent fault injection attacks on the command payloads or response data during transit or at temporal storage locations within the system.

The described transmission integrity scheme may enable integrity checks or validation of data communicated between various sources and destinations in a system, which may include requests of a host to peripherals and memories, and responses from the peripherals and memories to the host. Generally, the described aspects of transmission integrity or secure chip-wide communication, are intended to protect commands and/or data communicated throughout a system or chip with end-to-end security in request and/or response directions. In aspects, a consistent integrity scheme is employed across an entire system of components as described throughout this disclosure. For example, a secure framework of chip-wide communication can use error correction code (ECC) as a common communication scheme (e.g., transmission scheme employed by an entity sending commands and/or data over a fabric or bus). This communication scheme or protocol may refer to a format used when data is transported among or between entities of a system or chip. With respect to local communication to peripherals or memories, different formats can still be used without departing from the described aspects of secure chip-wide security. In some implementations, an integrity scheme is employed to take N-bits of data to M-bits of data, while checking (e.g., using ECC, cyclic redundancy check (CRC), Reed-Solomon codes, or the like) to verify that those M-bits are of an expected value. This may be advantageous relative preceding techniques based on parity, which allow for up to 50 percent of errors to escape detection and/or correction. Aspects of secure chip-wide communication are described throughout this disclosure that enable improved integrity or security for communicating data within a system or chip.

In aspects, the transmission integrity scheme may be implemented to protect data end-to-end in the system, from a destination all the way into a functional boundary of the host, and also in the reverse direction. Generally, data and commands are accompanied by integrity bits (e.g., ECC), and these integrity bits cover not only the transmission process across a fabric or bus, but can extend into destination storage and host function. Thus, the integrity bits (e.g., integrity metadata) generated by the host can extend all the way into memory, such as ROM or SRAM, and the same integrity bits are returned to the host later for checking or validation of the data. When a destination device cannot completely accept all of the integrity bits, the destination may implement a robust transformation process to ensure no vulnerabilities are introduced.

To safeguard computing systems from the compromising events described above, this document describes apparatuses and techniques for secure chip-wide communication that use integrity metadata and/or memory scrambling for secure transactions and data storage within a computing system. In some implementations, all execution flow critical memories of the system are protected by cryptographic encryption and decryption (e.g., scrambling), as well as the integrity bits. This may ensure that these memories cannot be attacked downstream of any integrity logic, and that any read or writes into memory are bound to a specific address that an attacker cannot alter. The following discussion describes an operating environment, example systems and components, example implementations of secure chip-wide communication, example methods, and a System-on-Chip (SoC) in which components of the operating environment may be embodied. In the context of the present disclosure, reference is made to the operating environment by way of example only.

Example Environment

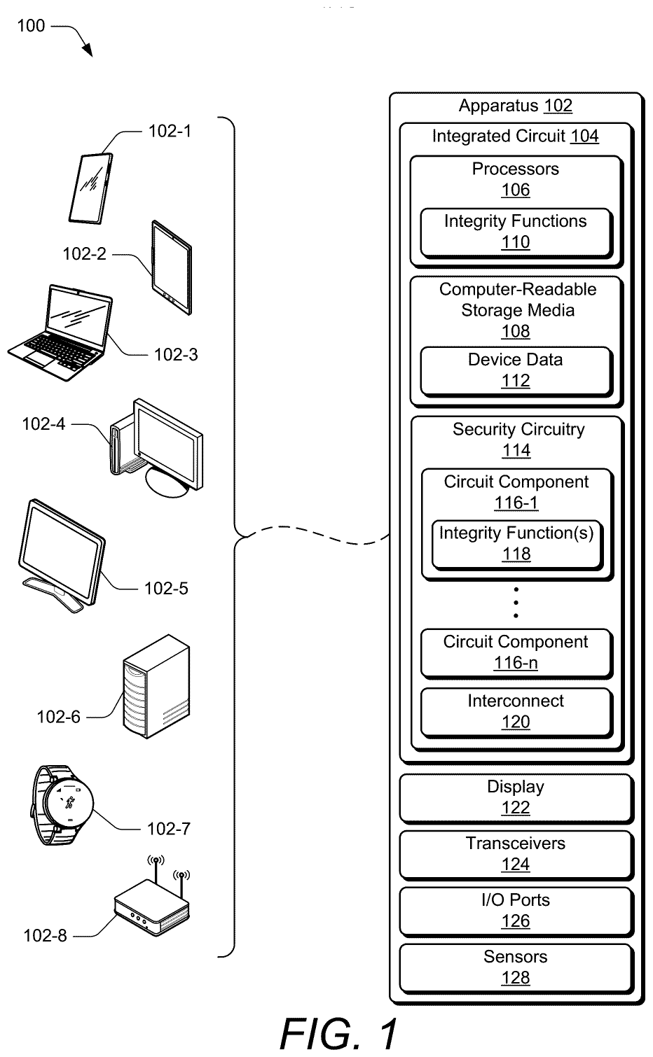

FIG. 1 illustrates an example environment 100 that includes an apparatus 102 in which aspects of secure chip-wide communication and associated communication integrity schemes can be implemented. The apparatus 102 may be implemented as any suitable device, some of which are illustrated as a smart-phone 102-1, a tablet computer 102-2, a laptop computer 102-3, a gaming console 102-4, a desktop computer 102-5, a server computer 102-6, a wearable computing device 102-7 (e.g., smart-watch), and a broadband router 102-8 (e.g., mobile hotspot). Although not shown, the apparatus 102 may also be implemented as any of a mobile station (e.g., fixed- or mobile-STA), a mobile communication device, a client device, a user equipment, a mobile phone, an entertainment device, a mobile gaming console, a personal media device, a media playback device, a health monitoring device, a drone, a camera, an Internet home appliance capable of wireless Internet access and browsing, an IoT device, and/or other types of electronic devices. The apparatus 102 may provide other functions or include components or interfaces omitted from FIG. 1 for the sake of clarity or visual brevity.

The apparatus 102 includes an integrated circuit 104 that utilizes one or more processors 106 and computer-readable media (CRM 108), which may include memory media or storage media. The processors 106 may be implemented as a general-purpose processor (e.g., of a multicore central-processing unit (CPU) or application processor (AP)), an application-specific integrated circuit (ASIC), graphics processing unit (GPU), or a system on chip (SoC) with other components of the apparatus 102 integrated therein. In aspects of secure chip-wide communication, one or more of the processors 106 may also include integrity functions as described throughout this disclosure.

The CRM 108 can include any suitable type of memory media or storage media, such as read-only memory (ROM), programmable ROM (PROM), random access memory (RAM), dynamic RAM (DRAM), static RAM (SRAM), or Flash memory. In the context of this discussion, the computer-readable media 108 of the apparatus 102 is implemented as at least one hardware-based or physical storage device, which does not include transitory signals or carrier waves. Applications, firmware, and/or an operating system (not shown) of the apparatus 102 can be embodied on the computer-readable media 108 as processor-executable instructions, which may be executed by the processor 106 to provide various functionalities described herein. The computer-readable media 108 may also store device data 112, such as user data or user media that is accessible through the applications, firmware, or operating system of the apparatus 102.

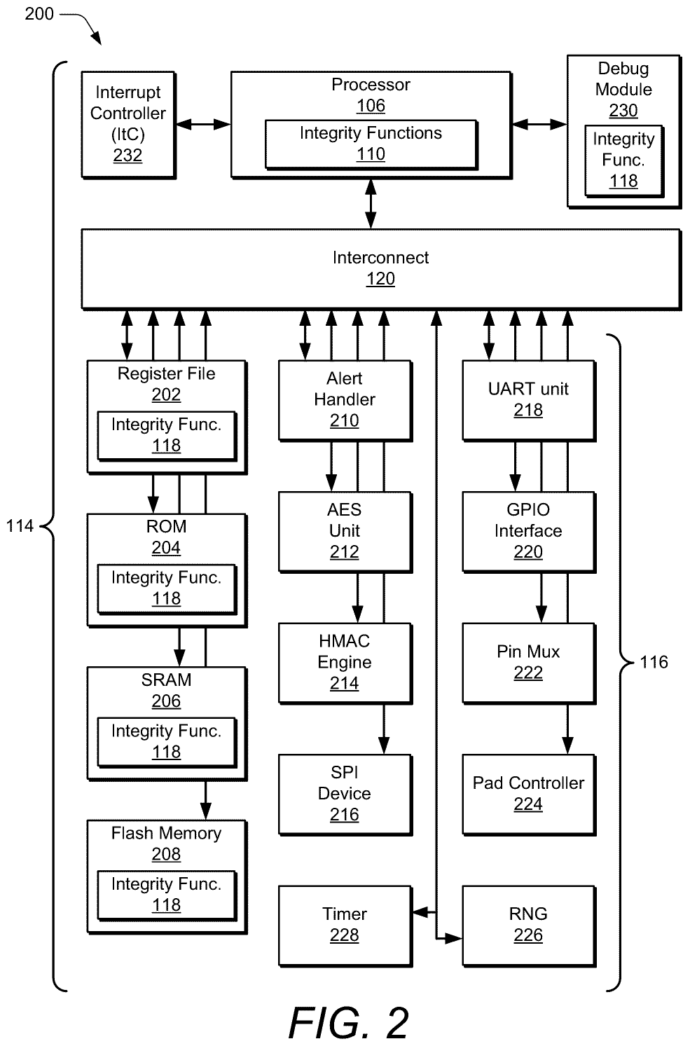

In this example, the integrated circuit 104 contains security circuitry 114. The apparatus 102, the integrated circuit 104, or the security circuitry 114 may implement a secure cryptographic processor. The security circuitry 114 may be implemented using one or more circuit components 116, for example, circuit component 116-1 through circuit component 116-n. The circuit components 116 may be organized to perform any number of operations to enable functionality of the apparatus 102. Examples of circuit components include a processor and multiple functional components and/or IP blocks as described in FIG. 2. The security circuitry 114 can be realized as, for example, a protected enclave, a trusted chip platform, a hardware-based root of trust (ROT) chip (e.g., a silicon RoT), and so forth. Regardless of how or where the security circuitry 114 is incorporated into an electronic device, the security circuitry 114 may counter or deter many different types of attacks.

In aspects, the security circuitry 114 includes circuit components 116-1 through 116-n that provide or implement respective functions of the security circuitry 114, the integrated circuit 104, and/or the apparatus 102. To implement aspects of secure chip-wide communication, a circuitry component 116 includes one or more integrity functions 118 that may enable communication integrity between components of the security circuitry 114 and/or various encryption or scrambling operations to protect data of the apparatus 102. Generally, the integrity functions 118 of the security circuitry 114 and circuit components 116 may implement a data communication and/or storage scheme with mechanisms for validating request messages (e.g., command payloads) before consumption by components, validating response messages (e.g., response payloads) before consumption by the host or other bus masters, and/or scrambling of memories (e.g., instruction cache or SRAM) to provide strong address and data binding that may prevent physical memory attacks. Thus, aspects of secure chip-wide (or system-wide) communication may ensure integrity payloads persist through traversal of the interconnect 120 (e.g., fabric) and temporal storage locations of the apparatus 102. In some cases, the integrity functions 118 of a circuit component 116 include an integrity check function to verify integrity of command payloads received from a host before consumption and an integrity generate function to generate integrity bits to include in or append to response payloads sent to the host, which enables the host to verify integrity of the response payload before consumption. These are but a few examples of entities useful to enable secure chip-wide communication, the implementations and uses of which vary and are described throughout the disclosure.

As shown, the security circuitry 114 is coupled to an interconnect 120, which may couple components, peripherals, and/or destinations of the security circuitry with a host or host interface. The interconnect 120 can be realized using, for example, a bus, a switching fabric, a link, communication channels, or a bus network that enables the various circuit components to communicate. In some aspects, the interconnect includes a fabric that is implemented in accordance with a TileLink communication standard, which may include a TileLink Uncached Lightweight (TL-UL) fabric with an A channel and D channel configuration. Each of the circuit elements may be directly or indirectly coupled to the interconnect 120. The interconnect 120 may enable communication with data ports or interfaces of the apparatus 102 to enable circuit components to communicate with other devices or data networks.

The apparatus 102 may also include a display 122, transceivers 124, input/output ports (I/O ports 126) and/or sensors 128. The display 122 may be operably coupled with one of the processors 106 (e.g., graphics processing unit (GPU)) and configured to graphically present respective interfaces of an operating system or applications of the apparatus 102. The transceivers 124 may be configured to enable wired or wireless communication of data (e.g., device data 112) over wired or wireless networks according to any suitable communication protocol. The I/O ports 126 of the apparatus 102 may include universal serial bus (USB) ports, coaxial cable ports, and other serial or parallel connectors (including internal connectors) useful to couple the electronic device to various components, peripherals, or accessories such as keyboards, microphones, or cameras.

The apparatus 102 also includes sensors 128, which enable the apparatus 102 to sense various properties, variances, stimuli, or characteristics of an environment in which the apparatus 102 operates. For example, the sensors 128 may include various motion sensors, ambient light sensors, acoustic sensors, capacitive sensors, infrared sensors, temperature sensors, radar sensors, or magnetic sensors. Alternatively or additionally, the sensors 128 may enable interaction with, or receive input from, a user of apparatus 102, such as through touch sensing, gesture sensing, or proximity sensing.

Example Circuit Components

FIG. 2 illustrates at 200 example security circuitry 114 that includes multiple circuit components which can be implemented to support aspects of secure chip-wide communication. As shown, the security circuitry 114 includes a processor 106 that is coupled to an interconnect 120. Each of the processor 106, the multiple memories, and the multiple other circuit components 116 may be directly or indirectly coupled to the interconnect 120. In aspects, the components of FIG. 2 may be embodied as a secure computing platform or a secure System-on-Chip that implements a root-of-trust and/or other secure cryptographic features. Alternatively or additionally, the components of FIG. 2 may be implemented as one or more ICs or IP blocks of a system that are coupled by the interconnect 120, which may be implemented as a fabric that operably couples the components or IP blocks of the system.

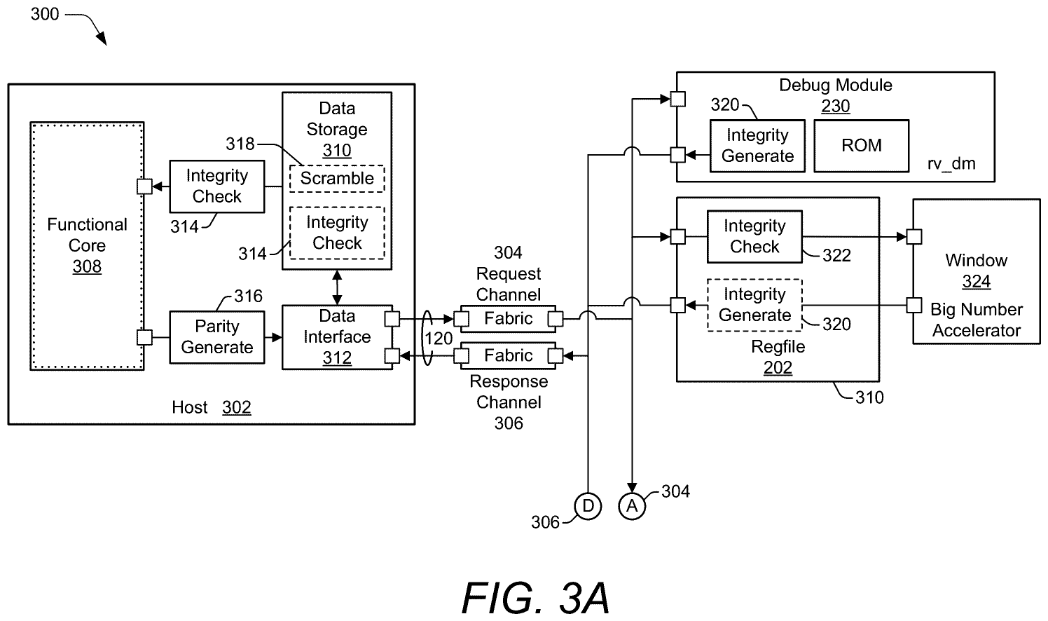

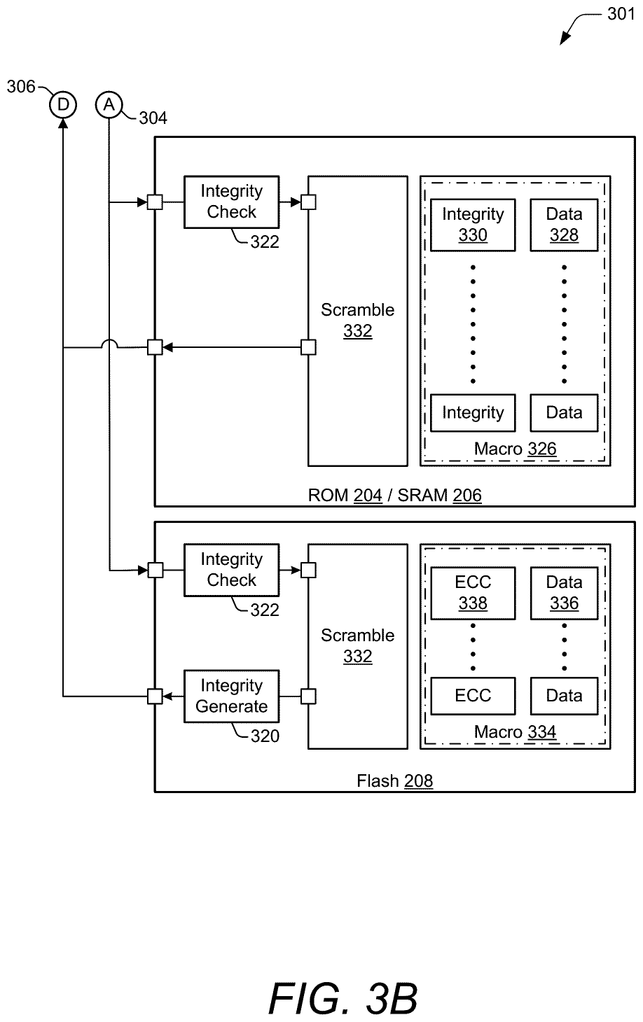

In aspects, the processor 106 of the security circuitry 114 may include integrity functions 110 for implementing aspects of secure chip-wide communication. In some cases, the integrity functions 110 include an integrity generate function to generate integrity bits to include in or append to request message (e.g., command payload) sent to components or destinations of the security circuitry 114, which enable the components to verify integrity of the request payload before consumption. The integrity functions 110 may also include an integrity check function to verify integrity of response messages (e.g., response payloads) received from respective ones of the components or destinations of the security circuitry 114. These are but a few examples of the integrity functions 110, the implementations and uses of which vary and are described with reference to FIGS. 3A-6 and throughout the disclosure.

The processor 106 may be coupled with the circuit components 116 through the interconnect 120 and/or directly coupled with other components or interfaces. As shown in FIG. 2, a system may include multiple circuit components 116 coupled to the interconnect 120 enabling interaction with the processor 106, which may function as a host of the system. In this example, the circuit components 116 include a register file 202 and various memories 204 through 208 that may be implemented with respective integrity functions 118. The circuit components 116 may include one or more memories of any suitable configuration (e.g., CRM 108) and include a ROM 204, an SRAM 206, and a Flash memory 208. Although not shown, circuit components 116 may include other memories (e.g., one-time programmable or DRAM memories) and/or memories coupled via other components, such as serial peripheral interface- (SPI-) or USB-coupled memories.

To implement aspects of secure chip-wide communication, the register file 202, ROM 204. SRAM 206, or Flash memory 208 may include integrity functions 118 for verifying data and other transactions implemented over the interconnect 120. In some cases, an integrity function 118 includes an integrity check function to verify integrity of command payloads received from a host before the component consumes the command payload. Alternatively or additionally, the integrity function 118 includes an integrity generate function to generate integrity bits to include in or append to response payloads sent by the component to the host, which enable the host to verify integrity of the response payload before consuming the response payload. These are but a few example implementations of the integrity functions 118, the implementations and uses of which vary and are described with reference to FIGS. 3A-6, and throughout the disclosure.

As shown in FIG. 2, the circuit components 116 may also include an alert handler 210, an advanced encryption standard (AES) unit (AES unit 212), a hash-based message authentication code (HMAC) engine (HMAC engine 214), and a serial peripheral interface (SPI) device (SPI device 216). The circuit components 116 can also include a universal asynchronous receiver/transmitter (UART) unit (UART unit 218), a general-purpose input/output (GPIO) interface (GPIO interface 220), a pin multiplexer (pin mux 222), and a pad controller 224. The multiple circuit components 116 can further include a random number generator (RNG 226), from which the other components may obtain high entropy values to use as authentication tokens, and a timer 228 (e.g., watchdog timer). Although certain examples of memories and other components 116 are depicted in FIG. 2 or described herein, a given implementation of the security circuitry 114 may include more, fewer, and/or different instances of processors, controllers, memories, modules, or peripheral devices, including duplicates thereof.

The illustrated circuit components can be operated synchronously based on one or more clock signals. Although not shown in FIG. 2, the security circuitry 114 may include at least one clock generator to generate the clock signals or may include reset circuitry to reset one or more individual components independently of each other, multiple components jointly, or an entire IC chip. Alternatively, the security circuitry 114 may receive at least one clock signal or a reset signal from a source that is external to the security circuitry 114, which source may or may not be on a separate chip. One or more separate components 116 may operate in respective individual clock domains. For instance, circuit components may be synchronized to a clock that is local to a respective component. Components in different clock domains may operate or communicate asynchronously with respect to one another.

Example implementations of the illustrated components are described below. The processor 106 may be realized as a “main,” “central,” or “core” processor for the security circuitry 114 through which functionalities of a host or bus controller are implemented. The processor 106 may, by way of example only, be implemented with a 32 bit, in-order reduced instruction set computing (RISC) core with a multi-stage pipeline. With, e.g., a RISC-V functionality, the processor may implement an M (machine) and a U (user) mode. Activating a reset pin (not shown) (e.g., through de-assertion of an active-low reset pin) causes the processor 106 to exit reset and begin executing code at its reset vector. The reset vector may begin in the ROM 204, which validates code in an embedded flash (e flash, not shown) before jumping to it. In other words, the code is expected to have been instantiated into the e flash before the reset is released. In some cases, resets throughout the security circuitry 114 can be made asynchronous active-low as per a comportability specification to support interoperability among the various circuit components. A reset may be generated by the alert handler 210 as a security countermeasure: by a watchdog timer; and so forth. Reset signals may also be sent to other circuit components, such as one of the memories or one of the other components 116.

Coupled to the processor 106 are a debug module 230 (DM) and an interrupt controller 232 (ItC), either of which may also be made comportable. The debug module 230 provides debug-access to the processor 106. By interfacing with certain pins of the IC, logic in the debug module 230 allows the processor 106 to enter a debug mode and provides an ability to inject code into the device (e.g., by emulating an instruction) or into a memory. The interrupt controller 232 may be disposed proximate to the processor 106. The interrupt controller 232 can accept a vector of interrupt sources from within the security circuitry 114. The interrupt controller 232 can also assign leveling and priority to the interrupts before forwarding them to the processor 106 for handling.

The processor 106 can provide any desired level of performance or include any internal circuit components. For example, the processor 106 can include at least one arithmetic logic unit (ALU) (e.g., including an “additional” ALU to calculate branch targets to remove a cycle of latency on taken conditional branches), a register file, a control unit, and input/output (I/O) units, and multiple pipeline stages. With multiple pipeline stages, a pipeline can perform register writeback to reduce a cycle of latency from loads and stores and prevent a pipeline stall where a response to a load or store is available the cycle after the request. The processor 106 can implement a single-cycle multiplier or produce an imprecise exception on an error response to a store, which allows the processor to continue executing past the store without waiting for the response. Although not depicted, the processor 106 specifically, or the security circuitry 114 generally, can include an instruction cache to provide single-cycle access times for instructions.

The ALU may be configured to perform arithmetic and logical operations on received data. The register file (e.g., register file 202), which is described further in reference to FIGS. 3A and 3B, may be an array of processor registers (e.g., control registers), serving as high-speed, semi-transient memory configured for quick data access during program or function processing. The register file may be tightly coupled to the ALU of the processor 106. To further facilitate access to the data, the register file may include multiple read ports or multiple write ports to enable the ALU and/or execution unit to contemporaneously retrieve multiple operands in a single cycle. The register file may be formed from flip-flops to accelerate reading and writing bits of the data. The control unit may be configured to control the flow of data throughout the system(s). The I/O units may include ports operably interfaced with other components of the device or security circuitry 114. Further aspects of the processor 106, circuit components 116, and integrity functions 110 and 118 are described with reference to FIGS. 3A-6 and throughout the disclosure.

FIGS. 3A and 3B illustrate at 300 and 301, respectively, an example configuration of system components that implement command or data transactions in accordance with one or more aspects of secure chip-wide communication. The example system configuration shown represents one of the many ways in which a system that support secure chip-wide communication may be implemented. As such, aspects of secure chip-wide communication may be implemented through similarly or differently configured systems, such as a system that includes one or more of the components described with reference to FIG. 2 and/or FIGS. 3A-6. Generally, aspects of secure chip-wide communication can be implemented in a system that includes a host and at least one destination or peripheral coupled to the host via an interconnect or fabric. As described herein, a host and destinations may each be configured differently from one another and/or implement different levels or types of data integrity when communicating with other components of the system. In the following description of FIGS. 3A-6, various system components are described in the context of various aspects of secure chip-wide communication that may be implemented as the components interact with one another to exchange or transact commands and/or data.

In some aspects of secure chip-wide communication, an integrity scheme may be employed in which data and commands are accompanied by integrity metadata or integrity bits by which integrity of the data or the commands may be verified. In some cases, error correction code (ECC) bits are used by the host and destinations to implement these integrity operations. Thus, an ECC-enabled integrity scheme covers not only a transmission process over a fabric or interconnect but extends into destination storage and host function. In other words, the integrity metadata generated by the host may extend all the way into memory and the same integrity metadata can be returned to the host for subsequent integrity verification. In cases when a destination or peripheral is unable to accept or store the integrity metadata, the destination or peripheral can be implemented with a robust data transformation process to ensure that vulnerabilities are not introduced, such as when the integrity metadata is stripped off within the destination. Additionally or alternatively, memories critical to execution flow can be protected through encryption/decryption, as well as integrity data. By so doing, the memories or system endpoints can be strengthened against attacks downstream of integrity logic, and any read or write into a memory can be bound to a specific address that an attacker is unable to alter. Thus, aspects of secure chip-wide communication may provide strong protection on all data, whether code or raw data, throughout the system and reduce an attack surface area available to potential attackers.

Returning to FIG. 3A, a host 302, functionalities of which may be implemented through processor 106, is coupled to destinations (e.g., components) of the example system through the interconnect 120. In this example, the interconnect 120 is configured as a TileLink Uncached Lightweight (TL-UL) fabric with a request channel 304 (channel A 304) and a response channel 306 (channel D 306) by which the host communicates with the destinations. By way of example, the host 302 may issue command payloads to the destinations over channel A 304 of the fabric and receive, from the destinations, response messages over channel D 306 of the fabric. As shown in FIGS. 3A and 3B, the host is operably coupled via the fabric to a debug module 230, a regfile 202, a memory module that may represent a ROM 204 or an SRAM 206, and a Flash memory 208. Although not shown, the host 302 may be operably coupled with any number of additional system components or destinations.

In aspects, the host 302 may represent any module or component that has or provides bus host functionality. The host 302 may be abstracted to, implemented with, and/or include a functional core 308, data storage 310, and a data interface 312 that couples the host 302 with the interconnect 120 of the system. Generally, the functional core 308 may represent logic or processing unit that implements and/or performs main functions of the host or system. As such, the functional core 308 may include one or more of a pipeline of a processor, a processor core, a main finite state machine of a direct memory access engine, or the like. The data storage 310 may include memory and registers that enable temporary storage of data transferred into the host and data transferred out of the host. The data interface 312 may be coupled between the data storage 310 and/or the functional core 308 and the interconnect 120 to enable or facilitate the exchange of data with destinations (e.g., memories and I/O) coupled to the interconnect 120. As such, the destinations may include any module or component that the host 302 can communicate with via the fabric, which may include ROM. SRAM. Flash memory, peripherals of the system, interfaces of the system, or the like.

In this example, the host 302 also includes an integrity check function 314 coupled between the data storage 310 and the functional core 308 (e.g., to verify data before consumption) and a parity generate function 316 coupled between the function core 308 and the data interface 312 (e.g., to provide integrity bits for outbound request and/or data payloads). In aspects, the integrity check function 314 and parity generate function 316 (or an integrity generate function) may verify integrity of data based on integrity metadata before consumption by the function core 308 and/or generate integrity metadata (e.g., ECC bits) for commands or data sent to destinations that enables a destination to verify integrity of the command or data before consumption. With respect to the host 302 and aspects of secure chip-wide communication, a boundary (dotted line) of the functional core 308 may be protected via other security mechanisms as it may not be possible for the integrity scheme to persist as the functional core 308 transforms data, such as ALU operations that do not preserve properties of the integrity metadata.

In aspects, transactions originated by the host 302 are accompanied by host-generated integrity metadata (e.g., ECC bits) that enable downstream destinations to verify integrity of the data received from the host as correct. In some aspects, the fabric between the host 302 and various destinations may also perform integrity checks on command messages or response messages, however, after a successful fabric-based integrity check, the integrity metadata should persist until the messages reach the appropriate host or destination. Accordingly, data returning to the host 302 from destination may also be accompanied by destination generated or supplied integrity metadata (e.g., ECC bits). In aspects, this integrity metadata should persist with the data or response message until the data reaches a boundary of the functional core where the integrity data can no longer be maintained or reaches a boundary of the functional core where the integrity data is converted into a different form. When the data reaches the boundary where the integrity data can no longer be maintained, the host 302 may check the integrity of the data before stripping off the integrity metadata and consuming the data. Alternatively, when the data reaches the boundary where the integrity data is converted, the host 302 may check the integrity of the data before calculating or determining new integrity metadata for the data (e.g., during data manipulation or processing by the functional core 308).

In this example, the data storage 310 of the host 302 also includes a scramble function block 318, which may enable scrambling of the data during transit through the host 302. In aspects, the scrambling mechanism of the scramble function block 318 may be address tweakable such that the scramble block 318 binds the scrambled data to a particular location in memory. In some cases, a counter or CTR scrambling mode is used in which a block cipher is employed to encrypt a 64 bit IV with the scrambling key in order to create a 64 bit keystream block that is bitwise XOR ed with the data in order to transform plaintext into ciphertext and vice versa. The IV can be assembled by concatenating a nonce with the word address.

Generally, the scramble mechanism used may be address tweakable. For example, a tweakable block cipher, in the context of the scramble mechanism, accepts a second input called the tweak along with its usual plaintext or ciphertext input. The tweak value, along with the key, selects the permutation computed by the cipher. When changing tweaks is sufficiently lightweight (compared with a usually fairly expensive key setup operation), then some interesting new operation modes become possible. The address tweak may be required in particular implementations as it binds the scrambled data to a particular location in memory. In some cases, the address itself should be scrambled to further increase difficulty of attack. In aspects, integrity metadata generated by the host 302 or destinations may persist with command messages (e.g., command payloads) and/or response messages (e.g., data payloads) through the fabric and/or any temporal storage elements of a system.

For example, as described herein, integrity metadata (e.g., ECC bits) may accompany or persist with data in or through TL-UL first-in first-out registers (TL-UL FIFOs), an instruction cache (i-cache), various registers of a processor (or host), a cryptography processor (e.g., big number accelerator). SRAM, registers or memories critical to execution control flow, or the like. In accordance with aspects of secure chip-wide communication, data integrity or payload integrity may be verified at both the host 302 and various destinations of the system prior to consumption. In some implementations, the host 302 and destinations of the system implement ECC as the integrity mechanism by which payload are verified, though other lightweight integrity mechanisms may be used (e.g., CRC bits or parity bits). Although ECC is implemented for integrity verification or validation, in aspects the correction feature of ECC is not used in that ECC detection is used for integrity verification. In some aspects, the ECC integrity encoding described may enable the detection of up to three bit errors per message or payload.

Returning to FIG. 3A, the host 302 may communicate commands or data with the debug module 230 and the regfile 202 using messages that include integrity metadata or integrity bits as described herein. In this example, the debug module 203 or debug memory (e.g., ROM, rv_dm) may be configured with an integrity generate function 320 to generate integrity metadata (e.g., ECC bits) for responses or data sent to the host 302. Due to the debug memory being ROM or read-only, the debug module may not include an integrity check function. In some cases, the debug module 230 may be lightly protected as access to this interface or memory is limited or valid only during a debug state of the system.

In aspects, the regfile 202 may include or provide integrity directly with data or response messages, such that the regfile 202 may optionally include an integrity generate function 320. The regfile 202 may include an integrity check function 322 for verifying integrity of command messages, request messages, or command payloads received from the host 302. In this example, the register file 202 is operably coupled with window access 324 to a big number accelerator. As noted, the data provided to or through the register file 202 may include integrity metadata or integrity bits and may be provided, such as from the window 324, directly to the fabric for communication to the host.

As shown at 301 of FIG. 3B, the host 302 may also communicate with memory destinations coupled to the fabric, which is illustrated as channel A 304 and channel D 306 from FIG. 3A. In this example, a first memory destination may represent ROM 204 and/or SRAM 206 that includes a memory macro 326 with scrambling protection (dashed line). In aspects, the ROM 204 or SRAM 206 may store data 328 received via the fabric with integrity metadata 330 that accompanies the data 328. In other words, some memories may directly store the integrity metadata (e.g., ECC bits, host-provided ECC) with the data to provide end-to-end integrity of data transactions through the system. This, the integrity metadata accompanies the data payload from origination at the host through the fabric and is stored along with the data in a memory destination. Additionally, the memory destination may include a scramble function 332 to scramble the data and integrity metadata prior to storage by the macro 326. As such, the depicted memory ROM 204/SRAM 206 does not include an integrity generation function because the integrity metadata 330 persists with the data 328 on entry into and through retrieval from the memory macro 326.

The host 302 may also communicate with the Flash memory 208 to store data to or access data from a Flash macro 334. Here, note that the Flash memory 208 may strip off the integrity data after an integrity check function 322 verifies integrity of the data. In some cases, size limitations of the Flash memory 208 may prevent the storage of both Flash ECC bits and integrity metadata with the data. As shown in FIG. 3B, the Flash macro 334 stores data 336 along with ECC bits 338 that are generated by the Flash memory 208 for error detection and correction of the data 336 when read from the Flash macro 334. Additionally, the Flash memory 208 may include a scramble function 332 to scramble the data 336 and/or ECC bits prior to storage by the Flash macro 334. Because the Flash memory 208 may not store the integrity metadata in an end-to-end fashion, the Flash memory 208 can include an integrity generate function 320 to generate integrity metadata for the data 336 when read from the Flash macro 334, which enables the host 302 to verify integrity of the data returned by the Flash memory 208.

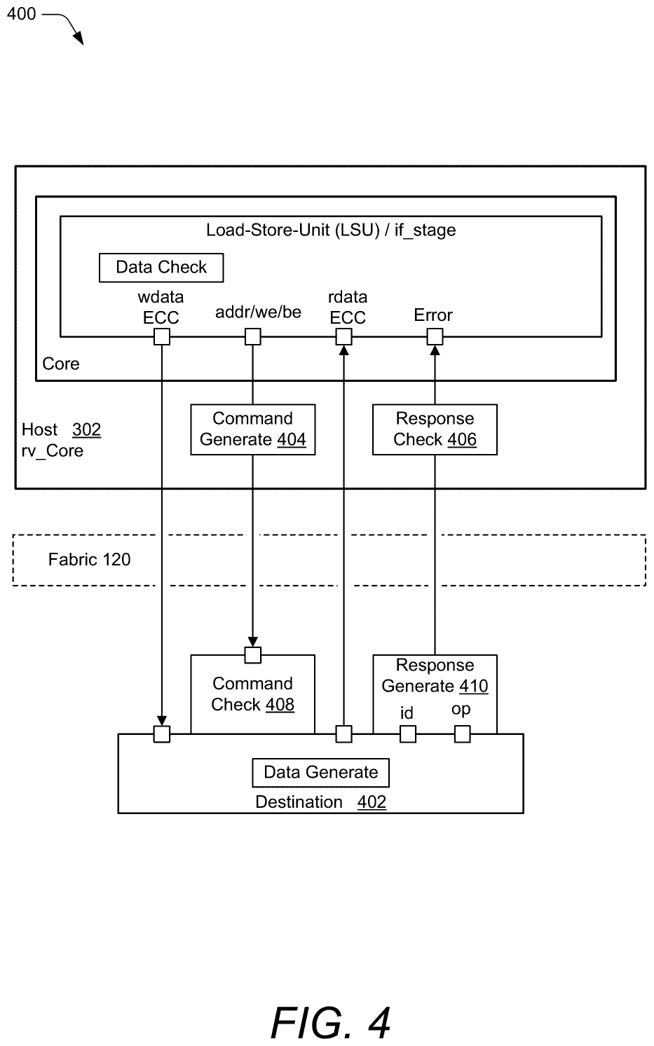

As another example, consider FIG. 4 in which an example system is illustrated at 400 that includes integrity functions for implementing aspects of secure chip-wide communication. The example system 400 of FIG. 4 may represent a simplified view of a system in which a host 302 is operably coupled to one or more destination 402 through a fabric 120. In this example, the host 302 (e.g., a RISC-V core) includes a command integrity generate function 404 (command generate 404) and a response integrity check function 406 (response check 406), which may correspond to host-based integrity functions 110, integrity check function 314, and/or parity/integrity generate function 316. When communicating with destinations of a system, the command generate function 404 may generate integrity bits to include in or append to a command message (e.g., command payload) sent to components or destinations and/or the response check function 406 may verify integrity of response messages (e.g., response payloads) received from respective components.

The destination 402 (e.g., peripheral or memory) may include a command integrity check function 408 (command check function 408) and a response integrity generate function 410 (response generate function 410), which may correspond to component integrity check functions 118, integrity generate function 320, and/or integrity check function 322. When communicating with a host of a system, the command check function 408 may verify integrity of command payloads received from a host (e.g., processor 106, host 302) before the component or destination consumes the command payload. Alternatively or additionally, the response generate function 410 may generate integrity bits to include in or append to response payloads sent by the component or destination to the host, which enables the host to verify integrity of the response payload before consuming the response payload.

With respect to peripheral destinations, such as USB- or SPI-based peripherals, these or other peripheral destinations may terminate either inside the register file (e.g., regfile 202) or a window (e.g., window 324) access to downstream functions. In aspects, incoming transactions at the destinations 402 are integrity checked, based on the integrity metadata, for correctness before consumption. For either register file or window termination, the integrity metadata (e.g., ECC bits) may be implemented such that the integrity data is generated upon read and returned to the host boundary, the integrity metadata is stored alongside the data and is directly returned to the host boundary, or when the data read progresses through the window, then downstream windowed integrity data may also be returned to host boundary. When windowed access has no integrity metadata, then the destination may generate the integrity metadata for the response and return this generated integrity data along with data returned.

Other considerations when designing for secure chip-wide communication may include using and/or enabling parity for additional or all peripheral registers, which may include all peripheral registers within a secure domain or space in the chip or system. In some system designs, there may be approximately 12 k configurable bits across existing peripherals (not all peripherals are instantiated), excluding various peripherals/interfaces that may include three I2Cs, one SPI-host, one rbox, and one dcd. In aspects, overhead for implementing chip-wide parity on all registers may run approximately 2 k˜3 k flops.

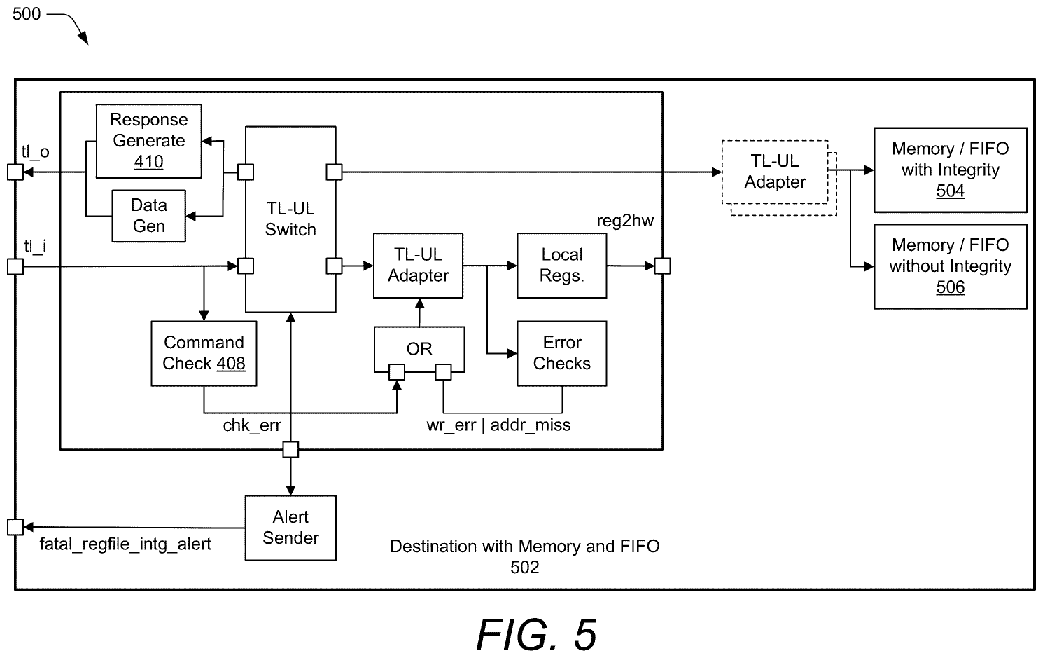

FIG. 5 illustrates at 500 an example peripheral that includes integrity functions for implementing aspects of secure chip-wide communication. In this example, a destination 502 is implemented with two instances of memory and FIFOs, a memory and FIFO 504 with integrity metadata storage and another memory and FIFO 506 without integrity metadata storage. Thus, the destination 502 may be configured to provide end-to-end integrity for at least some data stored by the memory and FIFO 504 with integrity. As shown in FIG. 5, the destination 502 may include a command check function 408 coupled to a TileLink input node and a response generate function 410 coupled to a TileLink output node. These integrity functions may correspond to component integrity check functions 118, integrity generate function 320, and/or integrity check function 322. When communicating with a host of a system, the command check function 408 may verify integrity of command payloads received from a host (e.g., processor 106, host 302) before the component or destination consumes the command payload. Alternatively or additionally, the response generate function 410 may generate integrity bits to include in or append to response payloads sent by the component or destination to the host, which enables the host to verify integrity of the response payload before consuming the response payload.

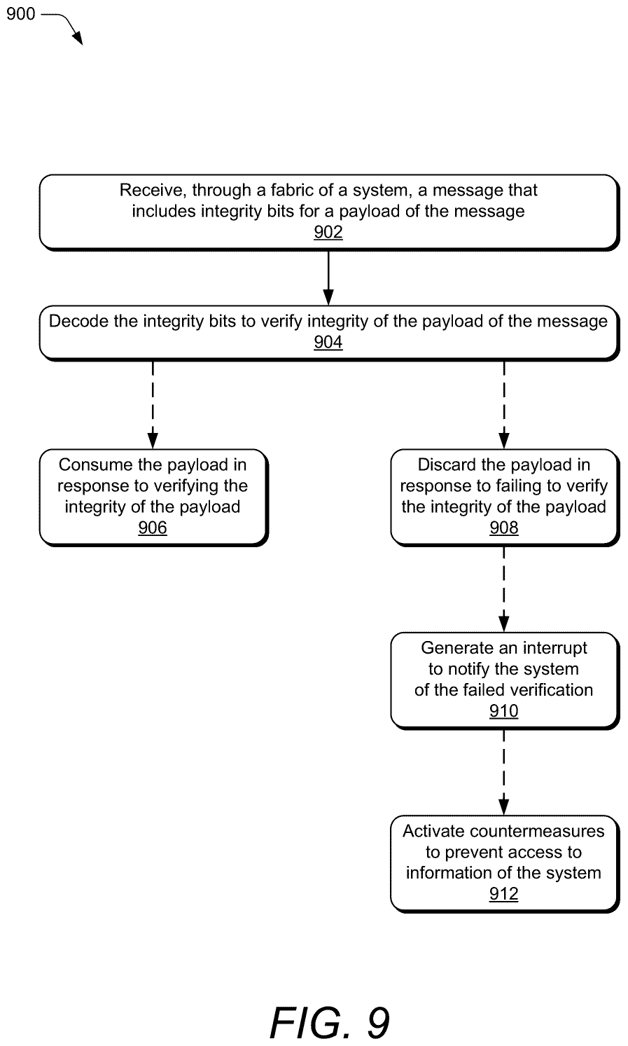

In some cases, however, the integrity bits may be stored in the memory and FIFO 504 such that the response generate function 410 does not need to generate new integrity bits for the data returned to the host. With reference to the command check function 408, when a command message or request message fails an integrity check, command check function 408 may be configured to discard the message and generate an alert (e.g., alert sender) or interrupt notifying the system of the failed integrity check. Alternatively or additionally, the system may employ security counter measures to protect sensitive data and/or secrets in response to the alert or interrupt. These are but a few examples of handling failed integrity checks, other of which are described with reference to FIG. 9 and throughout the disclosure.

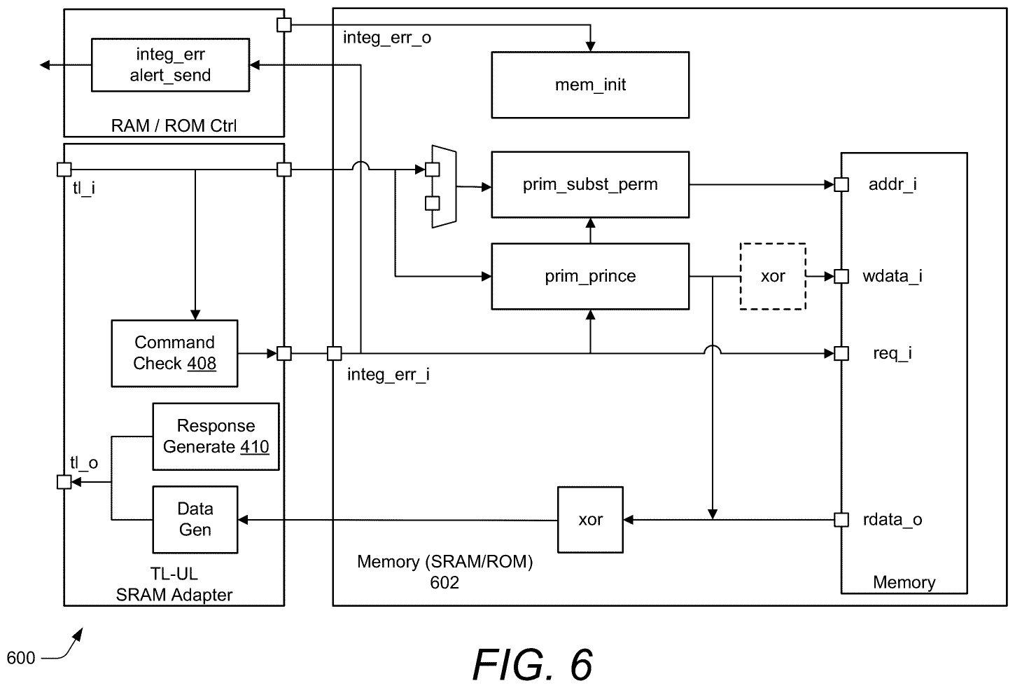

FIG. 6 illustrates at 600 an example memory component that includes integrity functions for implementing aspects of secure chip-wide communication. In this example, a memory 602 (e.g., SRAM, ROM) is implemented with a TL-UL fabric adapter and memory macro, which may represent SRAM or ROM functionality that supports the storage of integrity metadata (ECC bits). Thus, the memory 602 may be configured to provide end-to-end integrity for data stored by the memory macro with integrity metadata. As shown in FIG. 6, the memory 602 may include a command check function 408 coupled to a TileLink input node and a response generate function 410 coupled to a TileLink output node. These integrity functions may correspond to component integrity check functions 118, integrity generate function 320, and/or integrity check function 322. When communicating with a host of a system, the command check function 408 may verify integrity of command payloads received from a host (e.g., processor 106, host 302) before the memory consumes the command payload. Alternatively or additionally, the response generate function 410 may generate integrity bits to include in or append to response payloads sent by the memory to the host, which enables the host to verify integrity of the response payload before consuming the response payload.

In aspects, with reference to SRAM and ROM type destinations, incoming transactions may be checked for correctness before consumption. In some cases, the memory destinations are both scrambled, and integrity protected. For example, the scrambling protects attacks on the memory macro directly and prevents return of legally formed but incorrect data. In some cases, CTR scrambling is employed for secure communications over the interconnect 120. As described herein, the integrity for transactions can be either byte parity or ECC, the selection of which may be appropriate dependent on the module.

For example, for a main SRAM 206, where byte write performance may be important, parity should be used, whereas for retention SRAM, where byte write performance may not be important, ECC can be used. For cryptographic, big number accelerator memory, i-cache, and/or ROM, where byte write is not important or not possible, ECC can be used. Generally, upon a data read or data get, the behavior of the memory depends on whether its stored integrity data is consistent with the high-level selection. For example, if integrity data is the same, the stored integrity data be directly returned to the host boundary. On the other hand, if integrity data is different, the target integrity data must be calculated while the stored integrity data is checked for correctness.

Example Methods

Methods 700 through 1000, 1300, 1400, and 1600 are illustrated as respective sets of blocks that depict acts or operations that may be performed but are not necessarily limited to the order or combinations shown for performing the operations by the respective blocks. Further, any of one or more of the operations may be repeated, combined, reorganized, or linked to provide a wide array of additional and/or alternate methods. The described techniques are not limited to performance by one entity or multiple entities operating on one system or device. In aspects, operations or acts of the methods 700 through 1000, 1300, 1400, and 1600 are performed by or managed by a processor, security circuitry component, memory, integrity generate functions, integrity check functions, or other entity configured to implement secure chip-wide communication. For clarity, the methods are described with reference to the elements of FIG. 1 and/or entities, components, or configurations described with reference to FIGS. 2-6 and FIG. 17.

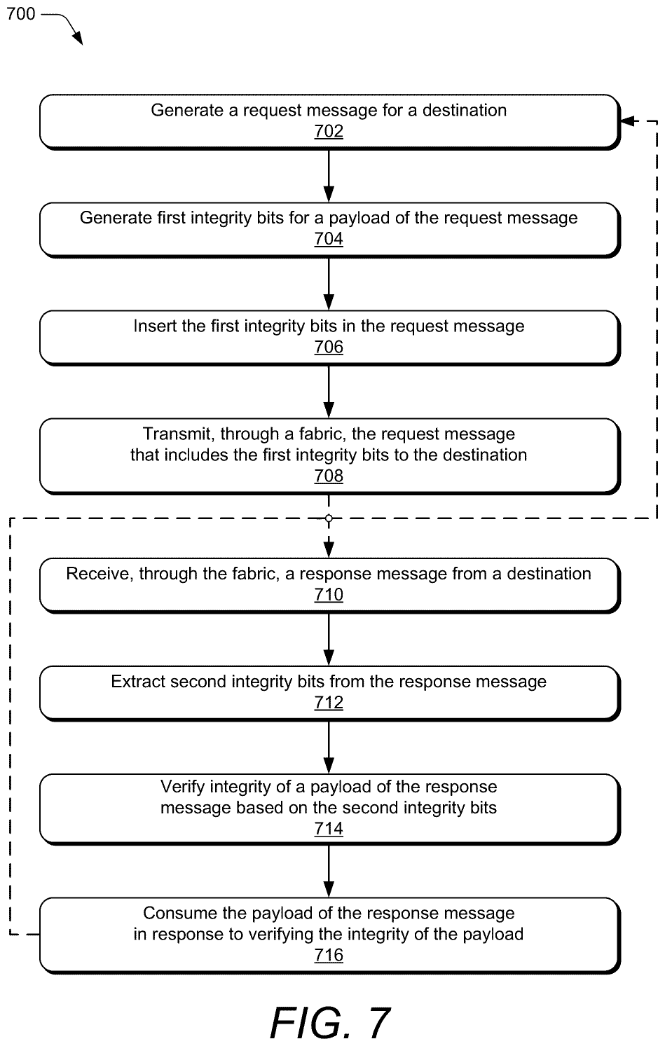

FIG. 7 illustrates example method(s) 700 for secure chip-wide communication that may be implemented by a host in accordance with one or more aspects. In various aspects, an integrity function 110 or host of a system may implement the operations of method 700 to securely communicate and/or utilize data of the system. In aspects, the operations of the method 700 may be repeated to send multiple request messages with integrity bits and/or verify integrity of multiple response messages that include integrity bits.

At 702, a request message (e.g., command message) for a destination is generated. The request message may include a payload of data for the destination to consume, which may include processing the data, storing the data, communicating the data, or so forth. Alternatively, or additionally, the request message may include a command or opcode configured to cause the destination to perform an operation or function as directed by the host.

At 704, first integrity bits for the payload of the request message are generated. In some cases, a command integrity generate function of the host generates integrity bits for the request message. The integrity bits may include any suitable type of encoding or encryption, such as ECC bits, CRC bits, asymmetric encryption, or the like. At 706, the first integrity bits are inserted in the request message or appended to data or another field of the payload of the request message.

At 708, the request message that includes the first integrity bits is transmitted through a fabric to the destination. In aspects, integrity of the request message may be verified or checked by an integrity check function of the fabric or interconnect through which the request message is transacted or communicated. From operation 708, the method 700 may return to operation 702 to generate another request message or proceed to operation 710 at which a response message is received from the destination or another destination.

At 710, a response message from a destination is received through the fabric. The response message may be a response to the last-sent request message to the destination or another response to a request message sent to another destination. The response message may include a payload of data or other information for the host to consume.

At 712, second integrity bits are extracted from the response message. The second integrity bits may include ECC bits or CRC bits for integrity verification, which are not used for error detection or error correction of the payload data or information. In some cases, the second integrity bits are the same as the first integrity bits generated by the host. In other cases, the second integrity bits are generated by the destination and inserted into the response message sent to the host.

At 714, the integrity of the payload of the response message is verified or validated based on the second integrity bits. In some cases, ECC or CRC values are decoded or determined for the payload to verify the integrity of the payload. This may include providing plaintext data bits and integrity bits to an ECC decoder to validate the plaintext based on the integrity bits received with the response message. Thus, an integrity check function of the host may calculate ECC bits or CRC bits for the payload and verify that the calculated ECC or CRC values match the integrity bits received with the payload.

At 716, the payload of the response message is consumed in response to verifying the integrity of the payload. Thus, the integrity of the payload of the response message is verified or validated before the host consumes or uses the data or information of the payload. Alternatively, the host may discard the response message in response to failing to verify the integrity of the payload (e.g., method 900). From operation 716, the method 700 may return to operation 702 to generate another request message or return to operation 710 to receive and process another response message that is received by the host.

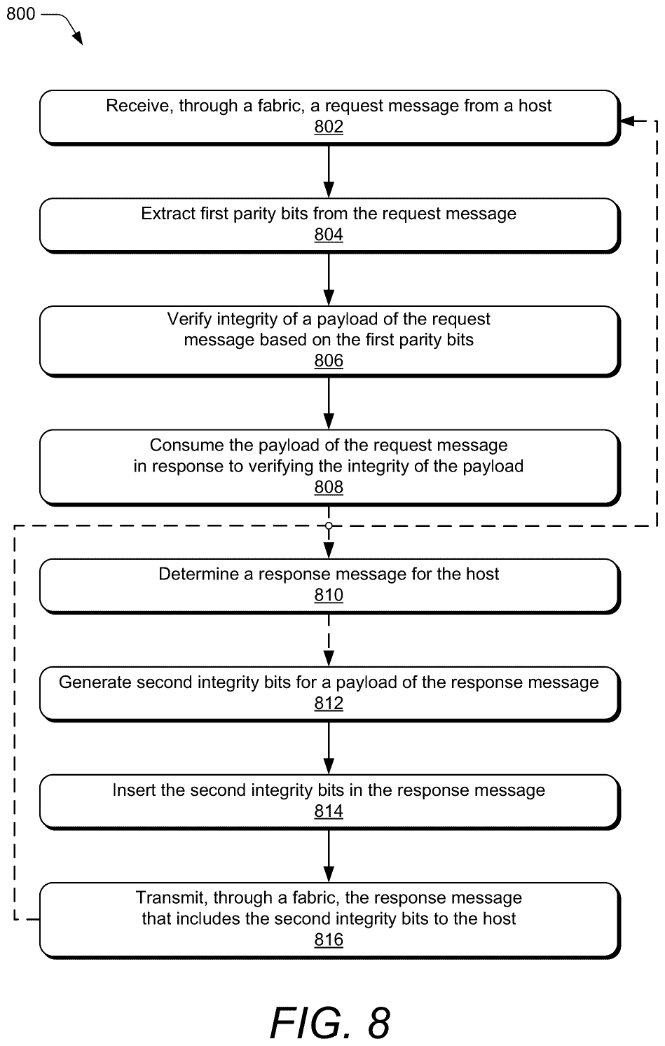

FIG. 8 illustrates example methods 800 for secure chip-wide communication that may be implemented by a destination in accordance with one or more aspects. In various aspects, an integrity function 118 or destination of a system may implement the operations of method 800 to securely communicate and/or utilize data of the system. In aspects, the operations of the method 800 may be repeated to receive multiple request messages with integrity bits and/or verify integrity of multiple request messages that include integrity bits.

At 802, a request message that includes integrity bits is received from a host through a fabric. The request message may include a payload of data for the destination to consume, which may include processing the data, storing the data, communicating the data, or so forth. Alternatively, or additionally, the request message may include a command or opcode configured to cause the destination to perform an operation or function as directed by the host.

At 804, first integrity bits are extracted from the request message. The first integrity bits may include ECC bits or CRC bits for integrity verification, which are not used for error detection or error correction of the payload data or information.

At 806, integrity of the payload of the request message is verified based on the first parity bits. In some cases, ECC or CRC values are decoded or determined for the payload to verify the integrity of the payload. This may include providing plaintext data bits and integrity bits to an ECC decoder to validate the plaintext based on the integrity bits received with the request message. Thus, an integrity check function of the destination may calculate ECC bits or CRC bits for the payload and verify that the calculated ECC or CRC values match the integrity bits received with the payload.

At 808, the payload of the request message is consumed in response to verifying the integrity of the payload. Thus, the integrity of the payload of the request message is verified or validated before the destination consumes or uses the data or information of the payload. Alternatively, the destination may discard the request message in response to failing to verify the integrity of the payload (e.g., method 900). From operation 808, the method 800 may return to operation 802 at which another request message is received from the host or proceed to operation 810 at which a response message is determined and sent by the destination to the host.

At 810, a response message is determined for the host. The response message may include resultant data of a function or operation of the destination, such as a processing operation, memory read operation, communication operation, or so forth.

Optionally at 812, second integrity bits for a payload of the response message are generated. In some cases, a response integrity generate function of the destination generates integrity bits for the response message. The integrity bits may include any suitable type of encoding or encryption, such as ECC bits, CRC bits, asymmetric encryption, or the like. Alternatively, the second integrity bits may be retrieved or received with the data of the payload for the response message. As such, the second integrity bits may be the same as the first integrity bits generated by the host. At 814, the second integrity bits are inserted into the response message or appended to data or another field of the payload of the response message.

At 816, the response message that includes the second integrity bits is transmitted through to the host through the fabric. The second integrity bits included with the response message may enable a host to verify integrity of the response message before consuming the payload of the response message. From operation 816, the method 800 may return to operation 802 to receive another request message from the host or return to operation 710 to determine and send another response message to the host.

FIG. 9 illustrates an example method 900 for verifying integrity of a payload of a message before consuming the payload in accordance with one or more aspects. In various aspects, an integrity function, host, or destination of a system may implement the operations of method 900 to verify integrity of a message payload before consuming data of the payload to prevent attacks from affecting data integrity and/or operation of the system.

At 902, a message that includes integrity bits for a payload of the message is received through a fabric. The message may include a command message from a host of a system or a response message from a destination or peripheral of the system. The integrity bits may include ECC bits or CRC bits for payload integrity verification, which are not used for error detection or error correction of the payload data or information.

At 904, the integrity bits and/or contents of the payload are decoded to verify integrity of the payload of the message. In some cases, ECC values or CRC values are decoded or determined for the payload to verify the integrity of the payload. This may include providing plaintext data bits and integrity bits to an ECC decoder to validate the plaintext based on the integrity bits received with the request message. From operation 904, the method 900 may proceed to operation 906 in response to verifying the integrity of the message or proceed to operation 908 in response to failing to verify the integrity of the message.

At 906, the payload of the message is consumed in response to verifying the integrity of the payload. After verification, the host or the destination may consume the payload of the message, which may ensure that the host or destination is consuming the correct data and not data that has been altered or tampered with by an attacker.

At 908, the payload is discarded in response to failing to verify the integrity of the payload. To prevent the host or the destination from consuming altered or incorrect data, the payload of the message is discarded. Optionally at 910, an interrupt or alert is generated to notify the system of the failed verification. In some cases, a security agent of the system is alerted, which may in turn cause a change in state of the system to prevent leakage of data. Optionally at 912, countermeasures are activated to prevent access to data or information of the system. In some cases, activating or engaging security countermeasures of the system may include erasing contents of one or more memories of the system, erasing one or more encryption keys of the system, resetting an entropy generation network of the system, altering a security state of the system, altering a power state of the system, or the like. By so doing, the system may prevent data integrity faults from exposing sensitive data or secret keys of the system.

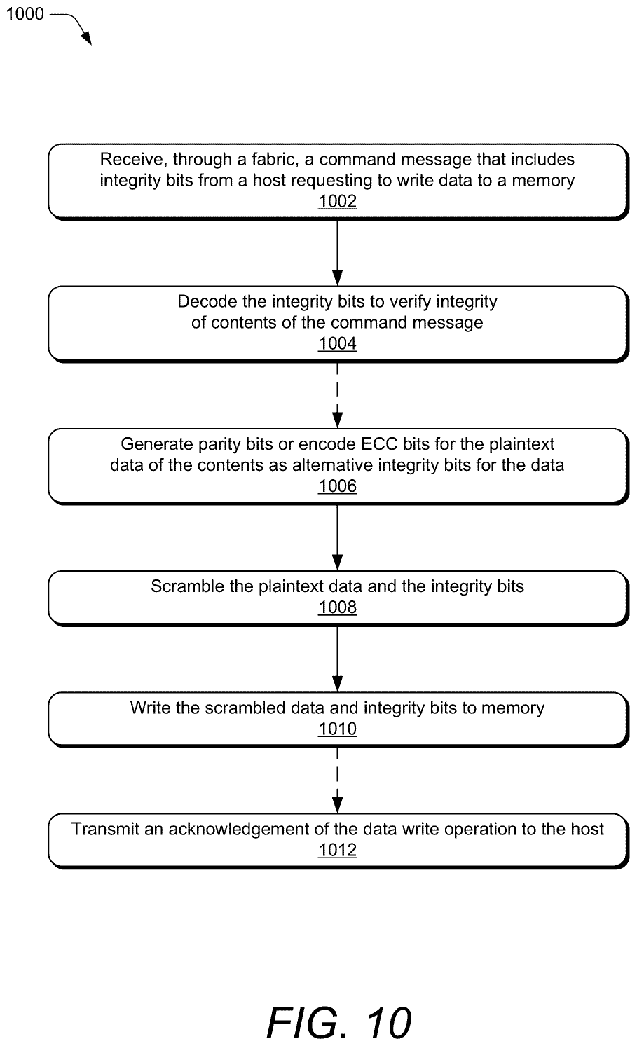

FIG. 10 illustrates an example method 1000 for writing data of a command message that includes integrity bits to memory in accordance with one or more aspects. In various aspects, an integrity function 118 or memory destination of a system may implement the operations of method 1000 to securely communicate and/or store data of the system.

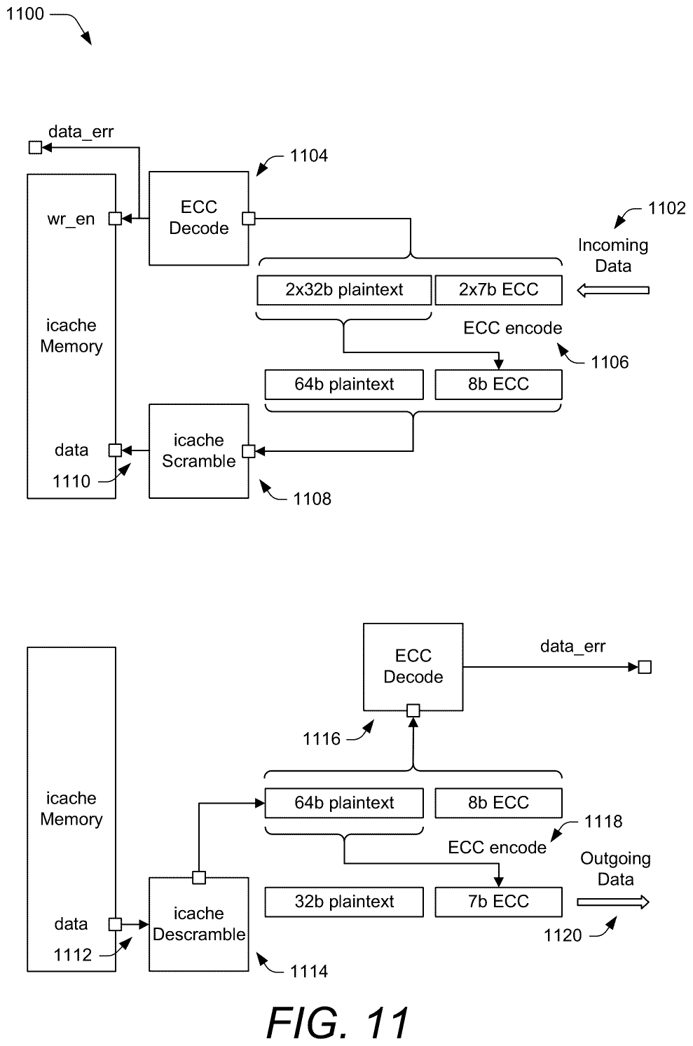

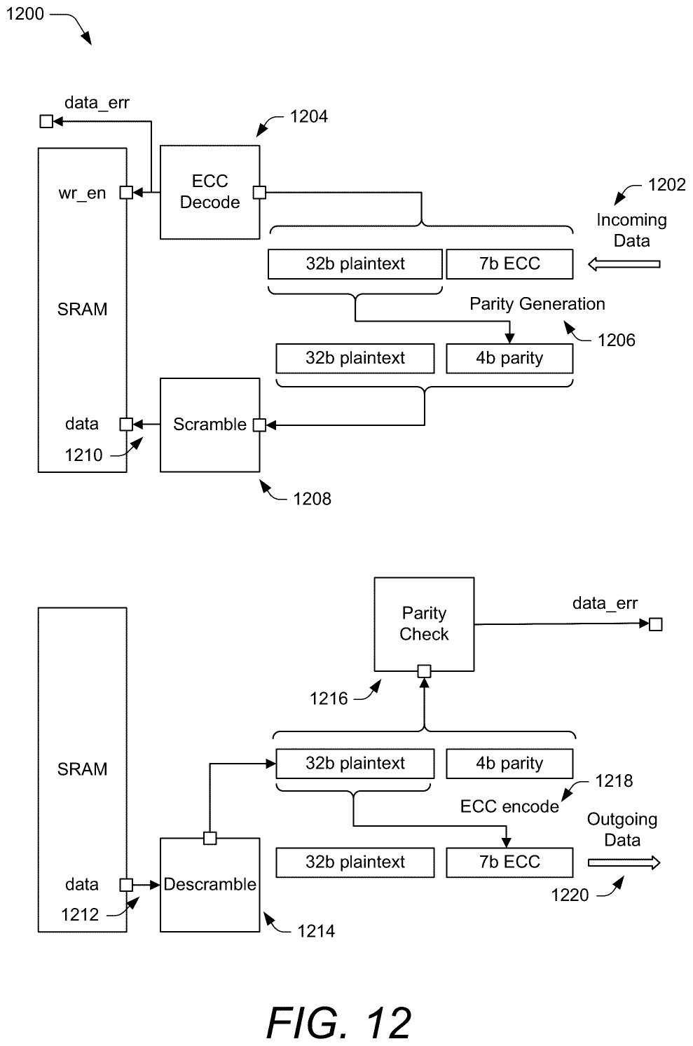

At 1002, a command message that includes integrity bits is received from a host through a fabric. The command message may be received by any suitable type of memory, such as an instruction cache (i-cache) or SRAM of the system. The command message (or request message) includes a request to write data of a payload of the command message to an address of the memory. By way of example, consider FIGS. 11 and 12 in which data transactions are performed by an i-cache memory and an SRAM, respectively. As shown in FIG. 11, an i-cache memory may receive incoming data at 1102 that includes ECC bits as integrity metadata. In FIG. 12, an SRAM receives incoming data at 1202 that includes ECC bits as integrity data.

At 1004, integrity bits of the command message are decoded to verify integrity of contents (e.g., payload data) of the command message. In the context of FIG. 11, an ECC decode block (e.g., integrity function) of the i-cache decodes at 1104 the plaintext and ECC bits of the command message received by the i-cache. In FIG. 12, an ECC decode block (e.g., integrity function) of the SRAM decodes at 1204 the plaintext and ECC bits of the command message received by the SRAM.

Optionally at 1006, parity bits are generated or ECC bits are encoded for the plaintext data of the command message contents as alternative integrity bits for the data. With reference to the i-cache example, ECC bits are encoded at 1106 for the plaintext data. In aspects, because byte write may not be important for i-cache, the i-cache can employ ECC as integrity check. In other aspects, because byte write performance can be important for SRAM, parity may be used to avoid read-modified-write delays. Note, in this example, it is assumed that even during a byte write, the bus data is fully populated (with potentially garbage or padding data) and correctly associated with ECC. In the context of FIG. 12, parity bits are generated at 1206 for the plaintext data to be written to the SRAM.

At 1008, the plaintext data of the command message contents and integrity bits are scrambled. As shown in FIG. 11, the scramble block of the i-cache at 1108 scrambles the plaintext and ECC bits. With reference to the SRAM example, the scramble block of the SRAM destination scrambles the plaintext data at 1208 and parity bits prior to storage in the SRAM.

At 1010, the scrambled data and integrity bits are written to the memory. Concluding the i-cache example, the scrambled data and ECC bits are written at 1110 to the i-cache memory. In FIG. 12, the SRAM unit writes the scrambled data and parity bits to the SRAM at 1210. Optionally at 1012, an acknowledgement of the data write operation is transmitted to the host through the fabric.

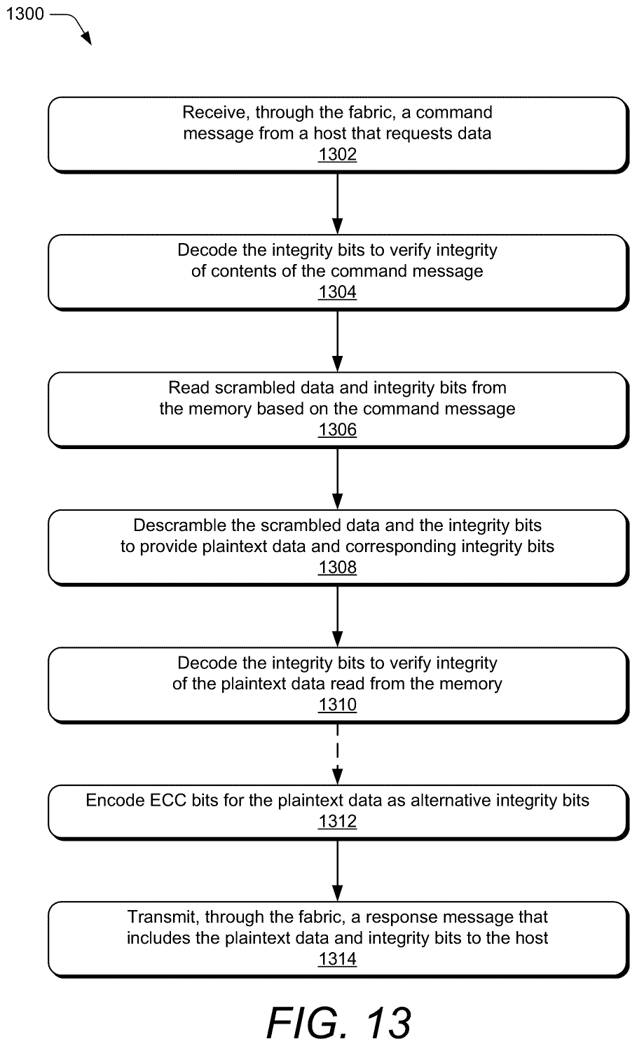

FIG. 13 illustrates an example method 1300 for accessing data of a memory and transmitting the data with integrity bits in accordance with one or more aspects. In various aspects, an integrity function 118 or memory destination of a system may implement the operations of method 1300 to securely communicate and/or access data of the system.

At 1302, a command message that requests data is received from a host through a fabric. The command message may be received by any suitable type of memory, such as an instruction cache (i-cache) or SRAM of the system. The command message (or request message) includes a request to read data from an address of the memory.

At 1304, integrity bits of the command message are decoded to verify integrity of contents (e.g., command payload) of the command message. The integrity bits may include ECC bits or CRC bits for integrity verification, which are not used for error detection or error correction of the payload data or information of the command message.

At 1306, scrambled data and integrity bits are read from the memory based on the address of the command message. Returning to the i-cache example of FIG. 11, at 1112 the scrambled data and ECC bits are read from the i-cache. In the context of the SRAM example of FIG. 12, the scrambled data and parity bits are read from the SRAM at 1212.

At 1308, the scrambled data and integrity bits are descrambled to provide plaintext data and corresponding integrity bits. As shown in FIG. 11, the descramble block of the i-cache at 1114 descrambles the scrambled plaintext and ECC bits that are read from the i-cache. With reference to the SRAM example, at 1214 the descramble block of the SRAM destination descrambles the scrambled plaintext data and parity bits read from SRAM.

At 1310, the integrity bits are decoded, or parity bits are checked, to verify integrity of the plaintext data read from the memory. With reference to the i-cache example, ECC bits are decoded at 1116 to verify integrity of the plaintext data. In the context of FIG. 12, parity bits are checked at 1216 for the plaintext data read from the SRAM.

Optionally at 1312. ECC bits are encoded for the plaintext data as alternative integrity bits for the plaintext data. In cases where the integrity bits received with the data are not stored with the data, new or second ECC bits may be generated for the data to include with the response message. In FIG. 11. ECC bits are encoded for the plaintext data of the i-cache at 1118. In the context of the SRAM example, ECC bits are generated at 1218 for the plaintext data read from the SRAM prior to transmission to the host.

At 1314, a response message that includes the plaintext data and the integrity bits is transmitted to the host through the fabric. Concluding the i-cache example, the plaintext data and ECC bits are transmitted at 1120 to the host as a response message. In FIG. 12, the SRAM unit transmits the plaintext data and ECC bits at 1220 to the host through the fabric as a response message to complete the data transaction with the host.

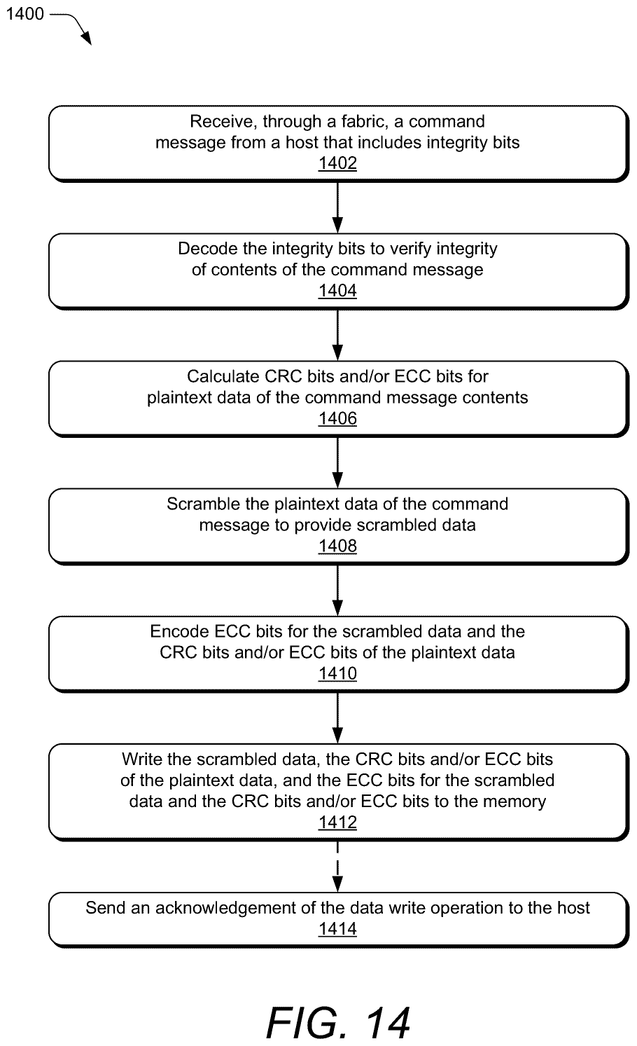

FIG. 14 illustrates an example method 1400 for writing data of a command message in memory with error correcting code bits in accordance with one or more aspects. In various aspects, an integrity function 118 or memory destination of a system may implement the operations of method 1400 to securely communicate and/or store data of the system.

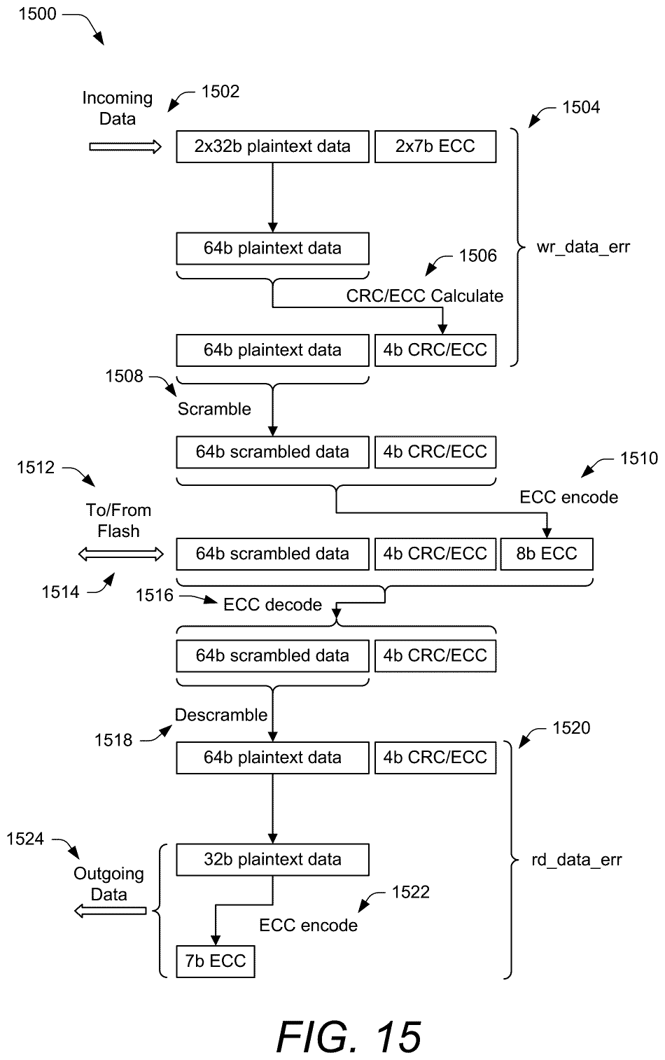

At 1402, a command message that includes integrity bits that requests data is received from a host through a fabric. The command message may be received by any suitable type of memory, such as a Flash memory of the system. The command message (or request message) includes a request to write data of a payload of the command message to an address of the memory. By way of example, consider FIG. 15 in which data transactions are performed by a Flash memory of a system. As shown in FIG. 15, the Flash memory block receive incoming data at 1502 that includes ECC bits as integrity metadata.

At 1404, integrity bits of the command message are decoded to verify integrity of contents (e.g., payload data) of the command message. In other words, incoming transactions of the memory may be checked for correctness before consumption. In the context of FIG. 15, an ECC decode block (e.g., integrity function) of the Flash may decode at 1504 the plaintext and ECC bits of the command message received by the Flash to verify the payload data. At 1406. CRC bits and/or ECC bits are calculated for the plaintext data of the command message contents. In the Flash memory example, a CRC block or ECC block may calculate at 1506 CRC bits or ECC bits for the plaintext of the data to be written to Flash.

At 1408, the plaintext data of the command message is scrambled to provide scrambled data. Flash destinations may be scrambled, which can protect from or prevent attacks on the flash macro directly and prevents return of legally formed but incorrect data. Due to its non-volatile nature, the Flash memory may use XEX for scrambling. Returning to FIG. 15, the plaintext data is scrambled at 1508 by a scramble block of the Flash unit.

At 1410, ECC bits are encoded for the scrambled data and the CRC bits and/or ECC bits. In some aspects of secure chip-wide communication. Flash is covered by ECC for endurance purposes. In some cases, a flash word size is 76-bits (64b data, 12b metadata) and ECC (8 bits) must be calculated from scrambled data as the scramble scheme affects the entire 64 block. Thus, the Flash block can use a slightly different data approach for protection. With reference to various ECC implementations for secure communication, for on flash programs, a CRC-4 or truncated ECC can be calculated on the original 64b data. The 64b data is then scrambled, and a new ECC is calculated on the concatenated scramble and CRC/ECC value. In the context of FIG. 15, scrambled data and CRC/ECC bits are ECC encoded at 1510 prior to writing to the Flash memory.

At 1412, the scrambled data, the CRC bits and/or ECC bits for the plaintext data, and the ECC bits for the scrambled data and the CRC bits and/or ECC bits are written to the memory. Concluding the method 1400 as shown in FIG. 15, the scrambled data, CRC/ECC bits, and ECC bits are written to Flash memory at 1512. Optionally at 1414, an acknowledgement of the data write operation is transmitted to the host through the fabric.

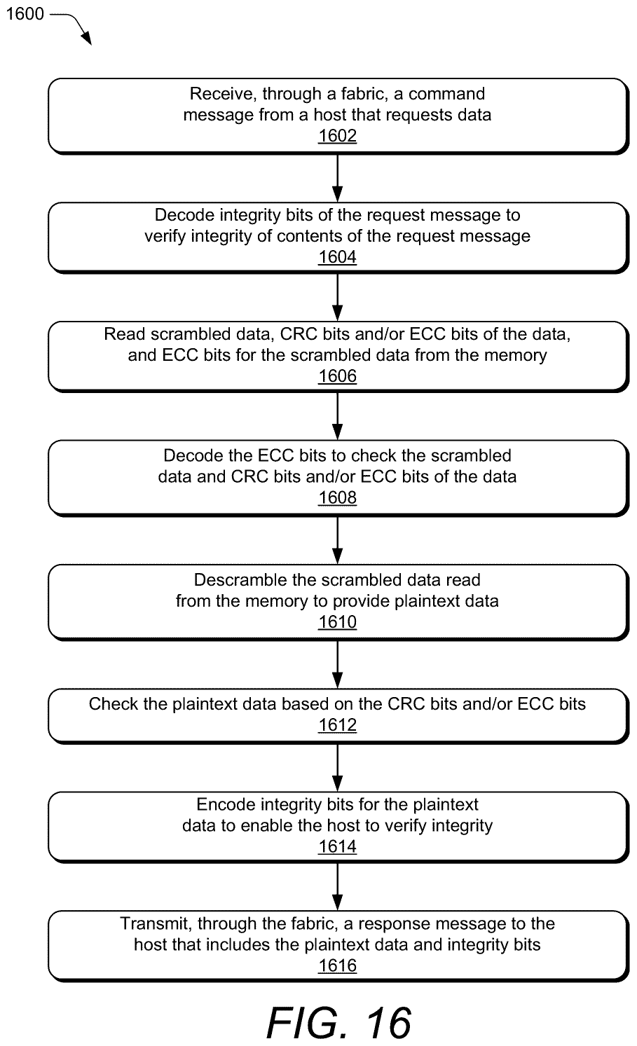

FIG. 16 illustrates an example method 1600 for accessing data of a memory and transmitting the data with generated integrity bits in accordance with one or more aspects. In various aspects, an integrity function 118 or memory destination of a system may implement the operations of method 1600 to securely communicate and/or access data of the system.

At 1602, a command message that requests data is received from a host through a fabric. The command message may be received by any suitable type of memory, such as a Flash memory of the system. The command message (or request message) includes a request to read data from an address of the memory.

At 1604, integrity bits of the command message are decoded to verify integrity of contents (e.g., payload) of the command message. The integrity bits may include ECC bits or CRC bits for integrity verification, which are not used for error detection or error correction of the payload data or information of the command message.

At 1606, scrambled data, ECC bits, and/or CRC bits are read from the memory based on the contents of the command message. Returning to the Flash memory example of FIG. 15, at 1514 the scrambled data, CRC/ECC bits, and ECC bits are read from the Flash memory.

At 1608, the ECC bits are decoded to check the scrambled data and the CRC bits and/or ECC bits of the data. As shown at 1516 of FIG. 15, an ECC block decodes the scrambled data, CRC/ECC bits, and ECC bits read from the Flash memory. At 1610, the scrambled data read from the memory is descrambled to provide plaintext data. In the context of the Flash example, a descramble block of the Flash unit descrambles the plaintext data read from the Flash memory at 1518.

At 1612, the plaintext data is checked based on the CRC bits and/or ECC bits of the plaintext data, which is illustrated at 1520 of FIG. 15. Thus, for on flash reads, the data can be ECC decoded and de-scrambled and checked against the original CRC-4/truncated ECC. If this check matches, the data is deemed error free. Here, note that the CRC-4/original-ECC may be scrambled by some other light-weight mechanism (reduced CTR) when stored into flash.

At 1614, ECC bits are encoded for the plaintext data to enable the host to verify integrity of the plaintext data. Because the integrity bits to not persist through storage to Flash memory, new or second integrity bits are generated by the Flash unit for the response message. In FIG. 15. ECC bits are encoded for the plaintext data of the Flash memory response at 1522.

At 1616, a response message that includes the plaintext data and the ECC bits for the plaintext data is transmitted to the host through the fabric. Concluding the Flash memory example of FIG. 15, the plaintext data and ECC bits are transmitted at 1524 by the Flash memory unit to the host as a response message.

Example System-on-Chip

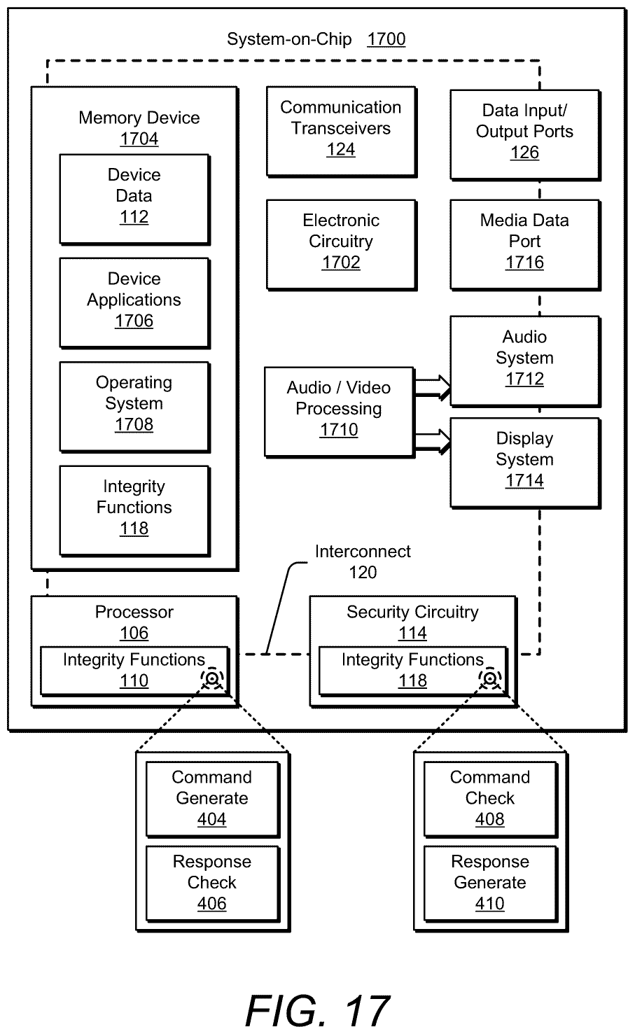

FIG. 17 illustrates various components of an example System-on-Chip 1700 (SoC 1700) that can implement secure chip-wide communication in accordance with one or more aspects. The SoC 1700 may be implemented as any single or multiple of a fixed, mobile, stand-alone, or embedded device: in any form of a consumer, computer, portable, user, server, communication, phone, navigation, gaming, audio, camera, messaging, media playback, and/or other type of SoC-enabled device, such as those apparatuses 102 depicted in or described with reference to FIG. 1. One or more of the illustrated components may be realized as discrete components, modules. IP blocks, or as integrated components on at least one integrated circuit of the SoC 1700. Generally, the various components of the SoC 1700 are coupled via an interconnect 120 and/or one or more fabrics that support communication between the components in accordance with one or more aspects of secure chip-wide communication.

The SoC 1700 can include one or more communication transceivers 124 that enable wired and/or wireless communication of device data 112, such as received data, transmitted data, or other information identified above. Examples of the communication transceivers 124 include a near-field communication (NFC) transceiver, wireless personal area network (PAN) (WPAN) radio compliant with various IEEE 802.15 (Bluetooth™) standards, a wireless local area network (LAN) (WLAN) radio compliant with any of the various IEEE 802.11 (WiFi™) standards, a wireless wide area network (WAN) (WWAN) radio (e.g., those that are Third Generation Partnership Project compliant (3GPP-compliant)) for cellular telephony, a wireless metropolitan area network (MAN) (WMAN) radio compliant with various IEEE 802.16 (WiMAX™) standards, an infrared (IR) transceiver compliant with an Infrared Data Association (IrDA) protocol, and a wired local area network (LAN) (WLAN) Ethernet transceiver.

The SoC 1700 may also include one or more data input/output ports 126 (I/O ports 126) via which any type of data, media content, and/or other inputs can be communicated, such as user-selectable inputs, messages, applications, music, television content, recorded video content, and any other type of audio, video, and/or image data received from any content and/or data source, including a sensor like a microphone or a camera. The data I/O ports 126 may include USB ports, coaxial cable ports, fiber optic ports for optical fiber interconnects or cabling, and other serial or parallel connectors (including internal connectors) for operably coupling a flash memory, optical media writer/reader (e.g., DVDs. CDs), and the like. These data I/O ports 126 may be used to couple the SoC to components, peripherals, or accessories such as keyboards, microphones, cameras, or other sensors.

The SoC 1700 of this example includes at least one processor 106 (e.g., any one or more of application processors, microprocessors, digital signal processors (DSPs), controllers, and the like), which can include a combined processor and memory system (e.g., implemented as part of an SoC), that processes (e.g., executes) computer-executable instructions to control operation of the device. The processor 106 or subsystem of the processor 106 may also include integrity functions 110 to implement various aspects of secure chip-wide communication as described herein. For example, the integrity functions of the processor 106 may include a command generate function 404 to generate integrity bits to include in or append to a command message (e.g., command payload) sent to components or destinations of the SoC 1700. Alternatively or additionally, the integrity functions 110 may include a response check function 406 to verify integrity of response messages (e.g., response payloads) received from respective components of the SoC 1700. The processor 106 may be implemented as an application processor, embedded controller, microcontroller, security processor, artificial intelligence (AI) accelerator, and the like. Generally, a processor or processing system may be implemented at least partially in hardware, which can include components of an integrated circuit or on chip system, a digital signal processor (DSP), an application-specific integrated circuit (ASIC), a field programmable gate array (FPGA), a complex programmable logic device (CPLD), and other implementations in silicon and/or other materials.

Alternatively or additionally, the SoC 1700 can be implemented with any one or combination of electronic circuitry, which may include software, hardware, firmware, or fixed logic circuitry that is implemented in connection with processing and control circuits, which are generally indicated at 1702 (as electronic circuitry 1702). This electronic circuitry 1702 can implement executable or hardware-based modules (not shown in FIG. 17), such as through processing/computer-executable instructions stored on computer-readable media, through logic circuitry and/or hardware (e.g., such as an FPGA), and so forth.

In aspects, the SoC 1700 includes an interconnect 120, which may include any one or more of a system bus, link, channels, interconnect, crossbar, data transfer system, or other switch fabric that couples the various components within the device to enable various aspects of signaling and/or communication with sparse encoding. A system bus or interconnect can include any one or a combination of different bus structures, such as a memory bus or memory controller, a peripheral bus, parity blocks. CRC blocks. ECC blocks. TL-UL fabric, a universal serial bus, and/or a processor or local bus that utilizes any of a variety of bus architectures.

The SoC 1700 also includes one or more memory devices 1704 that enable data storage, examples of which include random access memory (RAM), non-volatile memory (e.g., read-only memory (ROM), flash memory, erasable programmable read-only memory (EPROM), and electrically-erasable programmable read-only memory (EEPROM)), and a disk storage device. One or more of the memory devices 1704 may also include integrity functions 118 to implement various aspects of secure chip-wide communication as described herein. Thus, the memory device(s) 1704 can be distributed across different logical storage levels of a system as well as at different physical components. The memory device(s) 1704 provide data storage mechanisms to store the device data 112, other types of code and/or data, and various device applications 1706 (e.g., software applications or programs). For example, an operating system 1708 can be maintained as software instructions within the memory device 1704 and executed by the processor 106.

In some implementations, the SoC 1700 also includes an audio and/or video processing system 1710 that processes audio data and/or passes through the audio and video data to an audio system 1712 and/or to a display system 1714 (e.g., a video buffer or a screen of a smartphone or camera). The audio system 1712 and/or the display system 1714 may include any devices that process, display, and/or otherwise render audio, video, display, and/or image data. Display data and audio signals can be communicated to an audio component and/or to a display component via an RF (radio frequency) link. S video link. HDMI (high-definition multimedia interface), composite video link, component video link. DVI (digital video interface), analog audio connection, video bus, or other similar communication link, such as a media data port 1716. In some implementations, the audio system 1712 and/or the display system 1714 are external or separate components of the SoC 1700. Alternatively, the display system 1714, for example, can be an integrated component of the example SoC 1700, such as part of an integrated touch interface.

The SoC 1700 of FIG. 17 may be an example implementation of the apparatus 102 of FIG. 1, an example implementation of a device or system that can implement secure chip-wide communication as described with reference to FIG. 1 through FIG. 16. The SoC 1700 can thus include security circuitry 114, which can be a separate circuitry or IP blocks, or included as part of another IC chip or device, like the processor 106, the electronic circuitry 1702, or the memory device 1704. Accordingly, one or more of the illustrated components may be integrated on the same semiconductor substrate, semiconductor package. IC chip. SoC, or a single printed circuit board (PCB).

As shown, the security circuitry 114 is implemented with integrity functions 118, which may include instances of a command check function 408 and/or a response generate function 410. As such, the security circuitry 114 and integrity functions 118 may enable the SoC 1700 to implement aspects of secure chip-wide communication as described herein. For example, the command check function 408 may verify integrity of command payloads received from a host (e.g., processor 106) before the component or destination consumes the command payload. Alternatively or additionally, the response generate function 410 may generate integrity bits to include in or append to response payloads sent by the component or destination to the host, which enables the host to verify integrity of the response payload before consuming the response payload. The concepts of secure chip-wide communication as described herein can therefore be implemented by, or in conjunction with, the SoC 1700 of FIG. 17.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B.” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description. Although aspects of secure chip-wide communication have been described in language specific to certain features and/or methods, the subject of the appended claims is not necessarily limited to the specific features or methods described. Rather, the specific features and methods are disclosed as example implementations for secure chip-wide communication.

### Additional Examples

Examples of secure chip-wide communication are provided below:

Example 1: A method implemented by a host of a system for secure communication with at least one destination coupled to the host by an interconnect, the method comprising: generating a request message for a destination of the at least one destinations: generating first integrity bits for first data of the request message: inserting the first integrity bits in the request message; transmitting, through the interconnect, the request message that includes the first data and the first integrity bits to the destination: receiving, through the interconnect, a response message from the destination: extracting second integrity bits from the response message: verifying integrity of second data of the response message based on the second integrity bits: and consuming the second data of the response message in response to verifying the integrity of the second data of the response message.

Example 2: The method as recited by any of the examples, wherein the request message comprises a command message with a first payload that comprises the first data: or the response message comprises a response message with a second payload that comprises the second data.

Example 3: The method as recited by any of the examples, wherein generating the first integrity bits comprises generating error correction code (ECC) bits based on the first data of the request message: or verifying the integrity of the second data of the response message comprises decoding the second integrity bits as ECC bits for the payload of the request message.

Example 4: The method as recited by any of the examples, wherein the first integrity bits of the request message comprise first ECC bits and the first ECC bits of the request message are not used by the destination for error detection or error correction: or the second integrity bits of the response message comprise second ECC bits and the second ECC bits of the response message are not used by the host for error detection or error correction.

Example 5: The method as recited by any of the examples, wherein the second integrity bits of the response message comprise the first integrity bits of the request message that are generated by the host: or the second integrity bits of the response message comprise integrity bits generated by the destination.

Example 6: The method as recited by any of the examples, wherein the destination comprises a memory that is configured to store the first integrity bits with the first data of the request message.

Example 7: The method as recited by any of the examples, wherein the destination comprises a memory that, responsive to receiving the request message, is configured to: to generate ECC bits or cyclic redundancy check (CRC) for the first data of the request message: and store the ECC bits or CRC with the first data of the request message.

Example 8: The method as recited by any of the examples, wherein the first integrity bits of the request message or the second integrity bits of the response message comprise one of: parity bits determined based on the respective data of the request message or the response message: ECC bits determined based on the respective data of the request message or the response message: or CRC bits determined based on the respective data of the request message or the response message.

Example 9: The method as recited by any of the examples, wherein: the request message comprises an address of the destination, the first data comprising plaintext bits, and the first integrity bits that correspond to the first data of the request message: or the response message comprises an acknowledgement to the host: the second data comprising plaintext bits, and the second integrity bits that correspond to the second data of the response.

Example 10: The method as recited by any of the examples, wherein the interconnect that couples the host to the at least one destination comprises one of a fabric, a bus, a link, or one or more communication channels.

Example 11: The method as recited by any of the examples, wherein the interconnect that couples the host to the at least one destination is implemented in accordance with a TileLink communication standard.

Example 12: The method as recited by any of the examples, wherein the response message is a first response message, the method further comprising: receiving, through the interconnect, a second response message from the destination or another of the at least one destinations: extracting third integrity bits from the second response message: failing to verify integrity of third data of the second response message based on the third integrity bits: and discarding the third data of the second response message in response to failing to verify the integrity of the third data of the second response message.

Example 13: The method as recited by any of the examples, further comprising generating an interrupt to the host or a security entity of the system in response to failing to verify the third data of the second response message.

Example 14: The method as recited by any of the examples, further comprising, in response to failing to verify the third data of the second response message, engaging security countermeasures of the system that include at least one of: erasing contents of one or more memories of the system: erasing one or more encryption keys of the system: resetting an entropy generation network of the system: altering a security state of the system: or altering a power state of the system.

Example 15: An integrated circuit including circuitry for secure communication, the circuitry comprising: a host with a functional core: at least one destination that includes a memory block or a peripheral block: at least one interconnect coupling the host and the at least one destination; and respective interfaces embodied on the host and the at least one destination that are operably coupled to the interconnect and configured to perform the operations of any one of examples 1 to 14.

### CONCLUSION

Although aspects of the described systems and methods for implementing secure chip-wide communication have been described in language specific to features and/or methods, the subject of the appended claims is, as recited by any of the previous examples not necessarily limited to the specific features or methods described. Rather, the specific features and methods are disclosed as example implementations of secure chip-wide communication, and other equivalent features and methods are intended to be within the scope of the appended claims. Further, various aspects of secure chip-wide communication are described, and it is to be appreciated that each described aspect can be implemented independently or in connection with one or more other described aspects.

1. A method implemented by a host of a system for secure communication with at least one destination coupled to the host by an interconnect, the method comprising:
generating a request message for a destination of the at least one destination;
generating first integrity bits for first data of the request message;
inserting the first integrity bits in the request message;
transmitting, through the interconnect, the request message that includes the first data and the first integrity bits to the destination;
receiving, through the interconnect, a response message from the destination;
extracting second integrity bits from the response message;
verifying integrity of second data of the response message based on the second integrity bits; and
consuming the second data of the response message in response to verifying the integrity of the second data of the response message.

2. The method of claim 1, wherein:
the request message comprises a command message with a first payload that comprises the first data; or
the response message comprises a response message with a second payload that comprises the second data.

3. The method of claim 1, wherein:
generating the first integrity bits comprises generating error correction code (ECC) bits based on the first data of the request message; or
verifying the integrity of the second data of the response message comprises decoding the second integrity bits as ECC bits for a payload of the response message.

4. The method of claim 3, wherein:
the first integrity bits of the request message comprise first ECC bits and the first ECC bits of the request message are not used by the destination for error detection or error correction; or
the second integrity bits of the response message comprise second ECC bits and the second ECC bits of the response message are not used by the host for error detection or error correction.

5. The method of claim 1, wherein:
the second integrity bits of the response message comprise the first integrity bits of the request message that are generated by the host; or
the second integrity bits of the response message comprise integrity bits generated by the destination.

6. The method of claim 1, wherein the destination comprises a memory that is configured to store the first integrity bits with the first data of the request message.

7. The method of claim 1, wherein the destination comprises a memory that, responsive to receiving the request message, is configured to:
to generate ECC bits or cyclic redundancy check (CRC) for the first data of the request message; and
store the ECC bits or CRC with the first data of the request message.

8. The method of claim 1, wherein the first integrity bits of the request message or the second integrity bits of the response message comprise one of:
parity bits determined based on the respective data of the request message or the response message;
ECC bits determined based on the respective data of the request message or the response message; or
CRC bits determined based on the respective data of the request message or the response message.

9. The method of claim 1, wherein:
the request message comprises an address of the destination, the first data comprising plaintext bits, and the first integrity bits that correspond to the first data of the request message; or
the response message comprises an acknowledgement to the host; the second data comprising plaintext bits, and the second integrity bits that correspond to the second data of the response.

10. The method of claim 1, wherein the interconnect that couples the host to the at least one destination comprises one of a fabric, a bus, a link, or one or more communication channels.

11. The method of claim 1, wherein the interconnect that couples the host to the at least one destination is implemented in accordance with a TileLink communication standard.

12. The method of claim 1, wherein the response message is a first response message, the method further comprising:
receiving, through the interconnect, a second response message from the destination or another of the at least one destination;
extracting third integrity bits from the second response message;
failing to verify integrity of third data of the second response message based on the third integrity bits; and
discarding the third data of the second response message in response to failing to verify the integrity of the third data of the second response message.

13. The method of claim 12, further comprising generating an interrupt to the host or a security entity of the system in response to failing to verify the third data of the second response message.

14. The method of claim 12, further comprising, in response to failing to verify the third data of the second response message, engaging security countermeasures of the system that include at least one of:
erasing contents of one or more memories of the system;
erasing one or more encryption keys of the system;
resetting an entropy generation network of the system;
altering a security state of the system; or
altering a power state of the system.

15. An integrated circuit for comprising:
a host with a functional core;
at least one destination that includes a memory block or a peripheral block;
at least one interconnect coupling the host and the at least one destination; and
a secure communication system implemented at least in part by the host, the secure communication system configured to:
generate a request message for a destination of the at least one destination;
generate first integrity bits for first data of the request message;
insert the first integrity bits in the request message;
transmit, through the interconnect, the request message that includes the first data and the first integrity bits to the destination;
receive, through the interconnect, a response message from the destination;
extract second integrity bits from the response message;
verify integrity of second data of the response message based on the second integrity bits; and
consume the second data of the response message in response to verifying the integrity of the second data of the response message.

16. The integrated circuit of claim 15, wherein:
the request message comprises a command message with a first payload that comprises the first data; or
the response message comprises a response message with a second payload that comprises the second data.

17. The integrated circuit of claim 15, wherein:
to generate the first integrity bits comprises generating error correction code (ECC) bits based on the first data of the request message; or
to verify the integrity of the second data of the response message comprises decoding the second integrity bits as ECC bits for a payload of the response message.

18. The integrated circuit of claim 15, wherein:
the first integrity bits of the request message comprise first ECC bits and the first ECC bits of the request message are not used by the destination for error detection or error correction; or
the second integrity bits of the response message comprise second ECC bits and the second ECC bits of the response message are not used by the host for error detection or error correction.

19. The integrated circuit of claim 15, wherein:
the second integrity bits of the response message comprise the first integrity bits of the request message that are generated by the host; or
the second integrity bits of the response message comprise integrity bits generated by the destination.

20. The integrated circuit of claim 15, wherein the destination comprises a memory that is configured to store the first integrity bits with the first data of the request message.
